(19) United States
(12) Patent Application Publication
(10) Pub. No.: US 2002/0186875 A1
(43) Pub. Date: Dec. 12, 2002

(54) Computer methods for image pattern recognition in organic material

(76) Inventors: Glenna C. Burmer, Seattle, WA (US); Christopher A. Ciarcia, Los Alamos, NM (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/120,206

(22) Filed: Apr. 9, 2002

Related U.S. Application Data
(60) Provisional application No. 60/282,677, filed on Apr. 9, 2001.
(60) Provisional application No. 60/310,774, filed on Aug. 7, 2001.

(51) Int. Cl. G06K 9/00

(52) U.S. Cl. 382/133; 382/157; 382/224

(57) ABSTRACT

An expert system and software method for image recognition optimized for the repeating patterns characteristic of organic material. The method is performed by computing parameters across a two dimensional grid of pixels (rather than a one dimensional scan) with intensity values for each pixel having precision of eight significant bits. The parameters are fed to multiple neural networks, one for each parameter, which were each trained with images showing the tissue, structure, or nucleus to be recognized and trained with images likely to be presented that do not include the material to be recognized. Each neural network then outputs a measure of similarity of the unknown material to the known material on which the network was trained. The outputs of the multiple neural networks are aggregated by an associative voting matrix. A sub-neural network is used for each identified mode of data degradation in the input data.

### CROSS-REFERENCE TO RELATED APPLICATIONS

The present application claims priority from U.S. provisional patent application No. 60/282,677, filed Apr. 9, 2001, and from U.S. provisional patent application No. 60/310,774, filed Aug. 7, 2001. These and all other references set forth herein are incorporated herein by reference in their entirety and for all their teachings and disclosures, regardless of where the references may appear in this application.

### BACKGROUND

The human brain functions as a very powerful image processing system. As a consequence of extensive training and experience, a human histologist learns to recognize, either through a microscope or in an image, the distinctive features of hundreds of different tissue types and identify the distinctive features of structures, substructures, cell types, and nuclei that are the constituents of each type of tissue. By repeatedly observing these characteristic patterns, the human brain then generalizes this knowledge to accurately classify tissue types, tissue structures, tissue substructures, cell types, and nucleus types in novel specimens or images.

Furthermore, the human pathologist learns to distinguish the appearance of normal tissues from the appearance of tissues affected by one or more diseases that modify the appearance of particular cells, structures, or substructures within the specimen or alter the overall appearance of the tissue. With extensive training and experience, the human pathologist learns to distinguish and classify many different diseases that are associated with each tissue type.

Also, if a particular tissue component includes a molecule that is visible or has been marked using a chemical that shows a distinctive color through a microscope or in an image, the human can note the presence of this component and identify the type of cell or other tissue constituent in which the component appears.

### SUMMARY

The present invention includes an expert system that performs, in an automated fashion, various functions that are typically carried out by a histologist and/or pathologist such as one or more of those described above for tissue specimens where features spanning a pattern are detectible. The expert system is comprised of systems and methods that analyze images of such tissue specimens and (1) classify the tissue type, (2) determine whether a designated tissue structure, tissue substructure, or nucleus type is present, (3) identify with visible marking or with pixel coordinates such tissue structure, substructure, or nuclei in the image, and/or (4) classify the structure type, substructure type, cell type, and nuclei of a tissue constituent at a particular location in the image. In addition, the automated systems and methods can classify such tissue constituents as normal or abnormal (e.g. diseased) based upon a change in appearance of nuclei or a particular cell type, a change in appearance of a tissue structure or substructure, or a change in the overall appearance of the tissue. Also, the systems and methods can identify the locations where a sought component that includes a distinctive molecule appears in such specimens and classify the tissue type, tissue structure and substructure, as well as cell type that contains the sought component and whether the component is in the nucleus.

In addition to the benefit of reducing costs associated with salaries for histologists and/or pathologists, the invented systems and methods can be scaled up to perform large numbers of such analyses per hour. This makes it feasible, for example, to identify tissue constituents within an organism where a drug or other compound has bound, where a product of a specific gene sequence is expressed, or where a particular tissue component is localized. The invented systems and methods can be scaled to screen tens of thousands of compounds or genetic sequences in an organism with a single set of tissue samples. While this information could be gathered using a histologist and/or pathologist, the cost would be high and, even if cost were no object, the time required for such an analysis would interfere with completion of the project within an acceptable amount of time.

The invented systems and methods make use of image pattern recognition capabilities to discover information about images showing features of many cells fixed in relation to each other as a part of a tissue of an organism. It can also recognize a pattern across two dimensions in the surface appearance of cell nuclei for cells that a fixed in a tissue or are dissociated from their tissue of origin. The systems and methods can be used for cells from any kind of organism, including plants and animals. One value of the systems and methods in the near term is for the automated analysis of human tissues. The systems and methods provide the ability to automate, with an image capture system and a computer, a process to identify and classify tissue types, tissue structures, tissue substructures, cell types, and nuclear characteristics within a specimen. The image capture system can be any device that captures a high resolution image showing features of a tissue sample, including any device or process that involves scanning the sample in two or three spatial dimensions.

Automated Tissue Histology

The process used by histologists includes looking at tissue samples that contain many cells in fixed relationship to each other and identifying patterns that occur within the tissue. Different tissue types produce distinctive patterns that involve multiple cells, groups of cells, and/or multiple cell types. Different tissue structures and substructures also produce distinctive patterns that involve multiple cells and/or multiple cell types. The inter-cellular patterns are used by the expert system, as by a histologist, to identify tissue types, tissue structures, and tissue substructures within the tissues. Recognition of these characteristics by the automated systems and methods need not require the identification of individual nuclei, cells, or cell types within the sample, although identification can be aided by simultaneous use of such methods.

The automated systems and methods can identify individual cell types within the specimen from their relationships with each other across many cells, from their relationships with cells of other types, or from the appearance of their nuclei. With methods similar to those used to identify tissue type, tissue structures and substructures, the invented systems use analysis of patterns across at least two spatial dimensions in the nuclear image to identify individual cell types within the sample.

For the computer systems and methods to be able to recognize a tissue constituent based on repeating multi-cellular patterns, features spanning many cells as they occur in the tissue must be detectable in the image. To recognize a type of nucleus the system examines, patterns across the image of the nucleus. Depending upon the tissue type, the cell type of interest, and the method for generating the image, staining of the sample may or may not be desired. Some tissue components can be adequately detected without staining.

Visible light received through an optical lens is a one method for generating the image. However, any other process that captures a large enough image with high enough resolution can be used, including methods that utilize other frequencies of electromagnetic radiation or scanning techniques with a highly focused beam such as X-ray beam, or electron microscopy.

In one embodiment, the tissue samples are thin-sliced and mounted on microscope slides by conventional methods. Alternatively, an image of multiple cells within a tissue may be generated without removing the tissue from the organism. For example, there are microscopes that can show the cellular structure of human skin without removing the skin tissue and there are endoscopic microscopes that can show the cellular structure of the wall of the gastrointestinal tract, lungs, blood vessels and other internal areas accessible to such endoscopes. Similarly, invasive probes can be inserted into human tissues and used for in vivo imaging. The same methods for image analysis can be applied to images collected using these methods. Other in vivo image generation methods can also be used provided they can distinguish features in a multi-cellular image or distinguish a pattern on the surface of a nucleus with adequate resolution. These include image generation methods such as CT scan, MRI, ultrasound, or PET scan.

Once images are generated from the tissues, a set of data for each image is typically stored in the computer system. In one embodiment, approximately one million pixels per image and 256 different intensity levels for each of three colors for each pixel, for a total of 24 bits of information per pixel, at a minimum, are stored for each image. To use a computer to identify tissue types, tissue structures and nucleus types from this quantity of data, parameters are computed from the data to reduce the quantity by looking for patterns within the data across at least two spatial dimensions using the full range of 256 intensity values for each pixel. Once the parameters are computed, the amount of data required to represent the parameters of an image can be very small compared to the original image content. Thus, the parameter computation process retains information of interest and discards the rest of the information contained within the image.

Many parameters are computed from each image. Using this process, a signature can be generated for each tissue type, tissue structure, tissue substructure, and nucleus type, and this information can be assembled into a knowledge base for use by the expert system, preferably using a set of neural networks. Using the expert system, the data contained within each parameter from an unknown image is compared to corresponding parameters previously computed from other images where the tissue type, tissue structure, tissue substructure, cell types or nuclear characteristics are known. The expert system computes a similarity between the unknown image and the known images previously supplied to the expert system and a probability of likeness is computed for each comparison.

Automated Tissue Pathology

Normal tissues contain specific cell types that exhibit characteristic morphological features, functions and/or arrangements with other cells by virtue of their genetic programming. Normal tissues contain particular cell types in particular numbers or ratios, with precise spatial relationships relative to one another. These features tend to be within a fairly narrow range within the same normal tissues between different individuals. In addition to the cell types that provide a particular organ with the ability to serve its unique functions (for example, the epithelial or parenchymal cells), normal tissues also have cells that perform functions that are common across organs, such as blood vessels that contain hematologic cells, nerves that contain neurons and Schwann cells, structural cells such as fibroblasts (stromal cells) outside the central nervous system or glial cells in the brain, some inflammatory cells, and cells that provide the ability for motion or contraction of an organ (e.g., smooth muscle). The combinations of cells comprising these particular functions are comprised of patterns that are reproduced between different individuals for a particular organ or tissue, etc., and can be recognized by the methods described herein as “normal” for a particular tissue.

In abnormal states, alterations in the tissue that are detectible by this method can occur in one or more of several forms: (1) in the appearance of tissue structures (2) in the morphology of the nuclear characteristics of the cells, (3) in the ratios of particular cells, (4) in the appearance of cells that are not normal constituents of the organ, (5) in the loss of cells that should normally be present, or (6) by accumulations of abnormal material. Whether the source of injury is genetic, environmental, chemical, toxic, inflammatory, autoimmune, developmental, infectious, proliferative, neoplastic, accidental, or nutritional, characteristic changes occur that are outside the bounds of the normal features within an organ and can therefore be recognized and categorized by the methods of the present invention.

By collecting images of normal and abnormal tissue types, a signature for each normal tissue type and each known abnormal tissue type can be generated. The expert system can then replace the pathologist for determining whether a novel tissue sample is normal or fits a known abnormal tissue type. The computed parameters can also be used to determine which individual structures appear abnormal and which cells display abnormal nuclei and then compute measurements of the magnitudes of the abnormalities.

Automated Tissue Component Locator

While the ability to replace the histologist and/or pathologist with an automated system is an important aspect of these systems and methods, another useful aspect is the ability to determine the locations of structures or other components within tissues, including tissues of the human body that are identifiable in the image. One of the valuable applications of this aspect of the invention is to find cellular components that relate to a particular gene.

Scientists have been sequencing the human genome and the genomes of other organisms. However, knowing the nucleic acid or protein sequence of a gene does not necessarily indicate where the gene is expressed in the organism. Genes can show very different patterns of expression across tissues. Some genes may be widely expressed whereas others may show very discrete, localized patterns of expression. Gene products such as mRNA and/or proteins may be expressed in one or more cell types, in one or more tissue structures or substructures, within one or more tissues. Some genes may not be expressed in normal tissues but may be expressed during development or as a consequence of disease. Finding the cell types, tissue structures, tissue substructures, and tissue types in which a gene is expressed, producing a gene product, can be of great value. At present, very little is known about where and when genes are expressed in human tissues or in tissues of other organisms. To map the localization of expression of a single gene across the human body is a time consuming task for a histologist and/or pathologist. To map the expression patterns of a large number of genes across the human body is a monumental task. The invented expert systems and methods automate this task.

In addition to localizing gene products, the system can be used to find any localized component with an identifiable, distinctive structure or identifiable molecule, including metabolic by-products. The system can be used to find material that is secreted by a cell and/or material that is associated with the exterior of the cell, such as proteins, fatty acids, carbohydrates and lipids that have a distinctive structure or identifiable molecule that can be located in an image. The component of interest need not be fixed within the cell but may be confined instead to a certain domain within the cell. Examples of other localized tissue components that may be found include: a neural tangle, a neural plaque, or any drug, adjuvant, bacterium, virus, or prion that becomes localized.

By identifying and locating a gene product or other component of interest, the automated system can be used to find and identify nuclei types, cell types, tissue structures, tissue substructures, and tissue types where the component of interest occurs. The component of interest can be a drug or compound that is in the specimen. In this case, the drug or compound may act as a marker for another component within the image. Therefore, the system can be used to find components that are fixed within a cell, components that are localized to a part of a cell while not being fixed, and components that occur on the outside of a cell.

In one approach in the prior art, researchers have searched for locations of tissue and/or cellular components having an identifiable molecular structure by first applying to the tissue a marker that is known to attach to a component in a particular cell type within a particular tissue. Then, they also apply a second marker that will mark the molecular structure that is sought. If the two markers occur together, the cell where the sought molecular structure is expressed can be identified. A determination of whether the two markers occur together within an image can be made with a computer system, even though the computer system cannot identify cell locations or cell types except by detecting the location of the first marker in the image.

This prior art has a serious limitation because it is typically used when there is already a known marker that can mark a known cell type without marking other cell types. Such specific and selective markers are only known for a very small portion of the more than 1500 cell types found in the body.

The invented systems and methods can be used for tissue analysis without applying a marker that marks a known cell type. In the invented system, a single marker that attaches to a component of interest can be applied to one or more tissues from an organism. The systems and methods identify, in an automated fashion, the tissue type, the tissue structure and/or substructure, the cell type, and/or in some cases, the subcellular region in which the particular component of interest occurs.

This system is particularly valuable for studying the expression of genes across multiple tissues. In this case, the researcher utilizes a marker that selectively attaches to the mRNA, or other gene product for a gene of interest, and applies this marker to many tissue samples from many locations within the organism. The invented systems and methods are then used to analyze an image of each desired tissue sample, identify each location of a marker within the images, and then identify and classify the tissue types, tissue structures, tissue substructures, cell types and/or subcellular structures where the marker occurs.

In addition to finding the locations where a component of interest occurs, quantitative methods can be used to determine how much of the component is present at a given location. Such quantitative methods are known in the prior art. For example, the number of molecules of the marker that attach to the tissue specimen is related to the number of molecules of the component that is present in the tissue. The number of molecules of the marker can be approximately determined by the intensity of the signal at a pixel within the image generated from the marker.

Certain aspects of the present invention are also discussed in the following United States provisional patent applications, all of which are hereby incorporated by reference in their entirety. Application No. 60/265,438, entitled PPF Characteristic Tissue/Cell Pattern Features, filed Jan. 30, 2001; application No. 60/265,448, entitled TTFWT Characteristic Tissue/Cell Features, filed Jan. 30, 2001; application No. 60/265,449, entitled IDG Characteristic Tissue/Cell Transform Features, filed Jan. 30, 2001; application No. 60/265,450, entitled PPT Characteristic Tissue/Cell Point Projection Transform Features, filed Jan. 30, 2001; application No. 60/265,451, entitled SVA, Characteristic Signal Variance Features, filed Jan. 30, 2001; application No. 60/265,452, entitled RDPH Characteristic Tissue/Cell Features, filed Jan. 30, 2001.

### DESCRIPTION OF THE DRAWINGS

FIG. 1 diagrams the overall system.

FIG. 2 shows object segmentation.

FIG. 3 shows how sample analysis windows may be taken from an object.

FIG. 4 lists six parameter computation (feature extraction) methods.

FIG. 5 shows the IDG parameter extraction method.

FIG. 6 shows a typical neural network of subnet used for recognition.

FIG. 7 shows the voting matrix for nuclei recognition.

FIG. 8 shows the voting matrix for tissue or structure recognition.

### DETAILED DESCRIPTION

Mounting

Tissue samples can be of tissue of fixed cells or of cells dissociated from their tissues such as blood cells. Inflammatory cells, or PAP smear cells. Tissue samples can be mounted onto microscope slides by conventional methods to present an exposed surface for viewing. Tissues can be fresh or immersed in preservative to preserve the tissue and tissue antigens and avoid postmortem deterioration. For example, tissues that have been fresh-frozen or immersed in preservative and then frozen or embedded in a substance such as paraffin, plastic, epoxy resin, or celloidin can be sectioned on a cryostat or sliding microtome or a vibratome and mounted onto microscope slides.

Staining

Depending upon the tissue type of interest, the cell type of interest, and the desired method for generating the image, staining of the sample may or may not be required. Some cellular components can be adequately detected without staining. Methods that may be used to generate images without staining include contrasting techniques such as differential interference contrast, Nomarsky differential interference contrast, stop-contrast (darkfield), phase-contrast, and polarization-contrast. Additional methods that may be used include techniques that do not depend upon reflectance such as Raman spectroscopy, as well as techniques that rely upon the excitation and emission of light such as epi-fluorescence.

In one embodiment, a general histological nuclear stain such as hematoxylin is used. Eosin, which colors many constituents within each tissue specimen and cell, can also be used. Hematoxylin is a blue to purple dye that imparts this color to basophilic substances (i.e., substances that have an affinity for bases). Therefore, areas around the nucleus, for instance, which contain high concentrations of nucleic acids, will appear blue. Eosin, conversely, is a red to pink dye that colors acidophilic substances. Protein, therefore, would stain red or pink. Glycogen appears as empty ragged spaces within the sample because glycogen is not stained by either hematoxylin or eosin.

Special stains may also be used, such as those used to visualize cell nuclei (Feulgen reaction), mast cells (Giemsa, toluidine blue), carbohydrates (periodic acid-Schiff, Alcian blue), connective tissue (trichrome), lipids (Sudan black, oil red 0), micro-organisms (Gram, acid fast), Nissl substance (cresyl echt Violett), and myelin (Luxol fast blue). The pixel locations of these dyes can be found based on their distinctive colors alone.

Adding Markers

In some embodiments of the present invention, a marker is added to the samples. Because stain materials may reduce adhesion of the marker, the marker is typically added before the sample is stained. Alternatively, in some embodiments, it may be added after staining.

A marker is a molecule designed to adhere to a specific type of site in the tissue to render the site detectable in the image. The invented methods for determining tissue constituents at the location of a sought component detect the presence of some molecule that is detectable in the image at that location. Sometimes the sought component is directly detectable, such as where it is a drug that fluoresces or where it is a structure that, with or without stain, shows a distinctive shape that can be identified by pattern recognition. Other times, the sought component can be identified by adding a marker that will adhere to the sought component and facilitate its detection. Some markers cannot be detected directly and a tag may be added to the marker, such as by adding a radioactive molecule to the marker before the marker is applied to the sample. Molecules such as digoxigenin or biotin or enzymes such as horseradish peroxidase or alkaline phosphatase are tags that are commonly incorporated into markers to facilitate their indirect detection.

In the prior art, markers that are considered to be highly specific are markers that attach to known cellular components in known cells. In this invention, the objective is to search for components within tissue samples when it is not known in which tissue type, tissue structure, tissue substructure, and/or nucleus type the component might occur. This is accomplished by designing a marker that will find the component, applying the marker to tissue specimens that may contain many different tissues, structures, substructures, and cell types, and then determining whether any part of the specimens contains the marker and, therefore, the component of interest.

Markers may be antibodies, drugs, ligands, or other compounds that attach or bind to the component of interest and are radioactive or fluorescent, or have a distinctive color, or are otherwise detectable. Antibody markers and other markers may be used to bind to and identify an antibody, drug, ligand, or compound in the tissue specimen. An antibody or other primary binding marker that attaches to the component of interest may be indirectly detected by attaching to it another antibody (e.g., a secondary antibody) or other marker where the secondary antibody or marker is detectable.

Nucleic acid probes can also be used as markers. A probe is a nucleic acid that attaches or hybridizes to a gene product such as mRNA by nucleic acid type bonding (base pairing) or by steric interactions. The probe can be radioactive, fluorescent, have a distinctive color, or contain a tagging molecule such as digoxigenin or biotin. Probes can be directly detected or indirectly detected using a secondary marker that is in turn detectable.

Markers and tags that have distinctive colors or fluorescence or other visible indicia can be seen directly through a microscope or in an image. Other types of markers and tags can provide indicia that can be converted to detectable emissions or images. For example, radioactive molecules can be detected by such techniques as adding another material that fluoresces or emits light upon receiving radioactive emissions or adding materials that change color, like photographic emulsion or film, upon receiving radioactive energy.

Image Acquisition

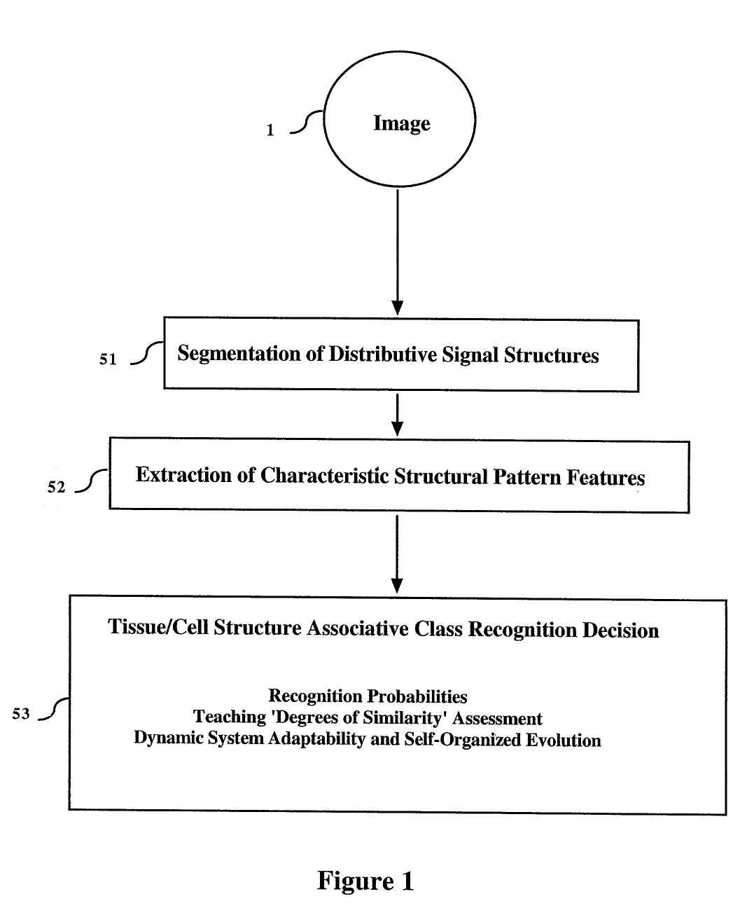

Turning to FIG. 1, after preparation of the sample, the next step in the process is to acquire an image 1 that can be processed by computer algorithms. The stored image data is transferred into numeric arrays, allowing computation of parameters and other numerical transformations. Some basic manipulations of the raw data that can be used include color separation, computation of gray scale statistics, thresholding and binarization operations, morphological operations, and convolution filters. These methods are commonly used to compute parameters from images.

In one example of how to acquire the image 1, the slides are placed under a light microscope such as a Zeiss Axioplan 2, which has a motorized XY stage, such as those marketed by Ludl and Prior, and an RGB (red-green-blue) digital camera, such as a DVC1310C, mounted on it. This exemplary camera captures 1300 by 1030 pixels. The camera is connected to a computer by an image capture board, such as the pixeLYNX board by Epix, and the acquired images are saved to the computer's hard disk drive. The camera is controlled by software, such as the CView software that is supplied by DVC, and the computer is connected to an RGB monitor for viewing of the color images.

The microscope is set at a magnification that allows discrimination of cell features for many cells at one time. For typical human tissues, a 10× or 20× magnification is preferred but other magnifications can be used. The field diaphragm and the condensor height and diaphragm are adjusted, the aperture is set, the illumination level is adjusted, the image is focused, and the image is taken. These steps are preferably automated by integration software that drives the microscope, motorized stage, and camera.

The images 1 are saved in a TIFF format, or other suitable format, which saves three color signals (typically red, green, and blue) in a 24-bit file format (8-bits per color).

For tissue recognition and tissue structure recognition, typically a resolution of about 1 micron of tissue per pixel is sufficient. This is the equivalent of using a camera having 10 micron pixels with a microscope having a 10× objective lens. A typical field of view at 10× is 630 microns by 480 microns. Given that the average cell in tissue has a 20 micron diameter, this view shows about 32 cells by 24 cells. For tissue recognition, the image must show tissue having a minimum dimension spanning at least about 120 microns. For tissue structure recognition, some very small structures can be recognized from an image showing tissue with a minimum dimension of at least about 60 microns. For nucleus recognition, the image need only be as large as a typical nucleus, about 20 microns, and the pixel size need only be as small as about 0.17 microns. For images taken with the DVC1310C camera using a 10× objective lens on the Zeiss Axioplan 2 microscope as described above, each image represents 0.87 mm by 0.69 mm and each pixel represents 0.66 microns by 0.66 microns. For recognition of nuclei, the objective lens can be changed to 20× and the resolution can be 0.11 microns of tissue per pixel.

Image Processing Systems

As shown in FIG. 1, an embodiment of the image processing systems and methods contains three major components: (1) an object segmentation module 51 whose function is the extraction of object data relating to tissue/cell sample structures from background signals, (2) a parameter computation (or “feature extraction”) module 52 that computes the characteristic structural pattern features across two (or three) spatial dimensions within the data and computes pixel intensity variations within this data across the spatial dimensions, and (3) a structural pattern recognition module 53 that makes the assessment of recognition probability (level of confidence) using an associative voting matrix architecture, typically using a plurality of neural networks. Each component is described in turn. Alternative embodiments may combine the functions of component (1) and component (2) into one module or may use any other expert system architecture for component (3). The invention may be embodied in software, on a computer readable medium or on a network signal, to be run on a general purpose computer or on a network of general purpose computers. As is known in the art, the neural network component may be implemented with dedicated circuits rather than with one or more general purpose computers. Signal Segmentation

One embodiment employs a method of signal segmentation procedure to extract and enhance color-coded (stained) signals and background structures to be used for form content-based feature analysis. The method separates the subject color image into three (3) RGB multi-spectral bands and computes the covariance matrix. This matrix is then diagonalized to determine the eigenvectors which represent a set of de-correlated planes ordered by decreasing levels of variance as a function of ‘color-clustered’ (structure correlated) signal strengths. Further steps in the segmentaion procedure vary with each parameter extraction method.

Parameter Extraction

Some aspects of the parameter extraction methods of the present invention require finding meaningful pattern information across two or three spatial dimensions in very small changes in pixel intensity values. For this reason, pixel data must be captured and processed with fine gradations in intensity. One embodiment employs a scale of 256 possible values (8 significant bits) for precision. 128 values (7 significant bits) will also work, although not as well, while 64 values (6 significant bits) yields serious degradation, and 32 values (5 significant bits) is beyond the limit for extraction of meaningful parameters using the methods of this aspect of the invention.

The pixel intensity data values are used in parameter extraction algorithms that operate in two or three dimensions, rather than in a one dimensional scan across the data, by using vector operations. To obtain pattern data across two dimensions, at least 6 pixels in each dimension are required to avoid confusion with noise. Thus, each element of the parameters is extracted from at least a two dimensional grid of pixels having a minimum dimension of 6 pixels. The smallest such object is 24 pixels in an octagon shape.

An embodiment of the system incorporates a parameter extraction module that computes the characteristic structural patterns within each of the segmented signals/objects. The tissue/cell structural patterns are distinctive and type specific. As such they make excellent type recognition discriminators. For tissue recognition and tissue structure recognition, in one embodiment, six different parameters are computed across a window that spans some of or all of the (sometimes segmented) image. In some embodiments, for recognition of nucleus type, the parameters can be computed independently for each region/object of interest and only one of the parameter computation algorithms, called IDG for integrated diffusion gradient transform, described below, is used.

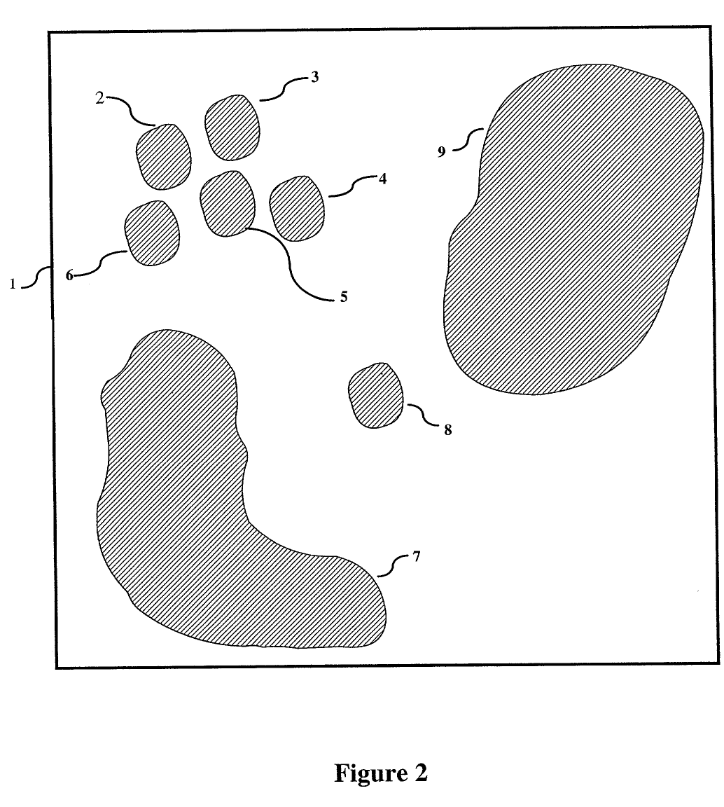

In one embodiment for tissue and structure recognition, no object segmentation is employed so all pixels may be used in the algorithm. For recognition of nuclei types, pixels representing nuclei are segmented from the rest of the data so that computation intensive steps will not get bogged down with data that has no useful information. As shown in FIG. 2, for recognition of nuclei, the segmentation procedure isolates imaged structures 2-9 that are defined as local regions where object recognition will be applied. These object-regions are imaged structures that have a high probability of encompassing nuclei. They will be subjected to form content based parameter computation that examines their 2-dimensional spatial and intensity distributive content to compute a signature of the nuclear material.

For recognition of nuclei, the initial image 1 is acquired as a color RGB image and then converted to an 8-bit grayscale data array with 256 possible intensity values for each pixel by employing a principal component analysis of the three color planes and extracting a composite image of the R, G and B color planes that is enhanced for contrast and detail. The composite 8-bit image is then subjected to a signal discontinuity enhancement procedure that is designed to increase the contrast between imaged object-regions and overall average background content so that the nuclei, which are stained dark, can be segmented into objects of interest and the remainder of the data can be discarded. Whenever there is a large intensity jump across a few pixels, the intermediate intensity pixels are dampened to a lower intensity, thereby creating a sharp edge around each clump of pixels showing one or more nuclei.

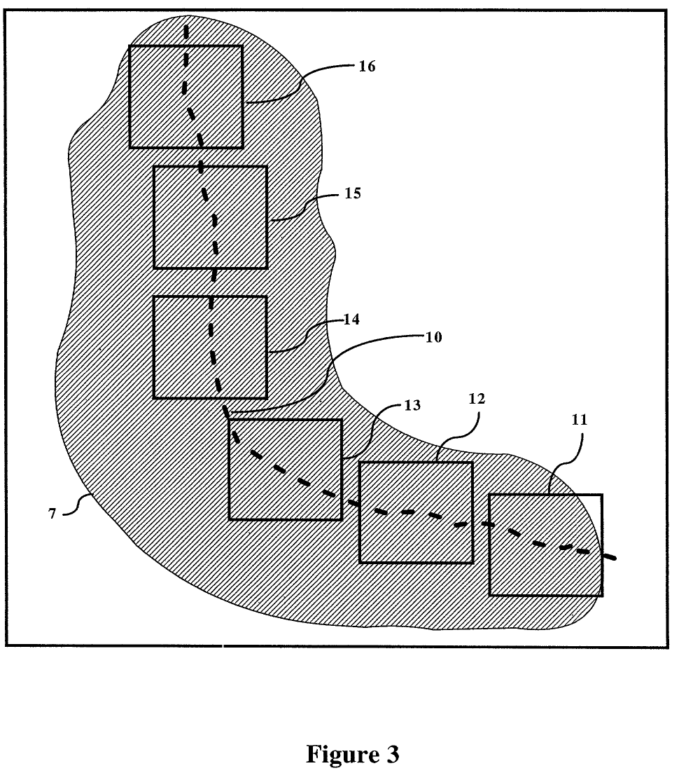

Segmentation of the objects 2-9 is then achieved by applying a localized N×N box deviation filter of a size approximately the same size as that of an individual nucleus, in a point to point, pixel-to-pixel fashion across the entire enhanced image. Those pixels that have significant intensity amplitude above the deviation filter statistical limits and are clustered together forming grouped objects of a size greater than or equal to an individual nucleus are identified individually, mapped and then defined as object-regions of interest. As shown in FIG. 3, a clump of nuclei appears as a singular object-region 7 which is a mapping that defines which pixels will be subjected to the feature extraction procedure; with actual measurements being made on the principal component enhanced 8-bit image at the same points indicated by the segmented object-region mapping.

For each nuclear object-region, a center-line 10 is defined that substantially divides the object-region along its longitudinal median. A series of six regional sampling analysis windows 11-16, each of a size approximately the same as that of an individual nucleus, are then centered on the median and placed in a uniform fashion along that line, and individual distributive intensity pattern measurements are computed across two spatial dimensions within each window. These measurements are normalized to be substantially invariant and comparative between different object-regional measurements taken from different images. By taking sample analysis windows from the center of each clump of pixels representing nuclei, the chances of including one or more nucleoli are very good. Nucleoli are one example of a nuclear component that shows distinctive patterns that are effective discriminants for nucleus types.

For recognition of nuclei, the parameter calculation used on each of the sampling windows 11-16 is called the ‘integrated diffusion gradient’ (IDG) of the spatial intensity distribution, discussed below. It is a set of measurements that automatically separate type specific pattern features by relative amplitude, spatial distribution, imaged form, and form variance into a set of characteristic form differentials. In one embodiment, twenty-one discrete IDG measures are computed for each of the six sample windows 11-16, for a total of 126 IDG calculations per window.

In one embodiment for recognition of nuclei, once the IDG parameters have been calculated for a each window, a characteristic vector for each object-region 7 is then created by incorporating the 126 measures from each sample window and two additional parameters. The first additional parameter is a measure of the object-region's intensity surface fill factor across the two spatial dimensions, thereby computing a “three-dimensional surface fractal” measurement. The second additional parameter is a measure of the region's relative working size compared to the entire imaged field-of-view. In combination, this set of measurements becomes a singular characteristic vector for each object-region. It contains 128 measures of the patterned form. All of the measures are independent of traditional cross-sectional nuclear boundary shape characterization and they may not incorporate or require nuclear boundary definition or delineation. Ideally, they are taken entirely within the boundary of a single nucleus or cluster of pixels representing nuclei.

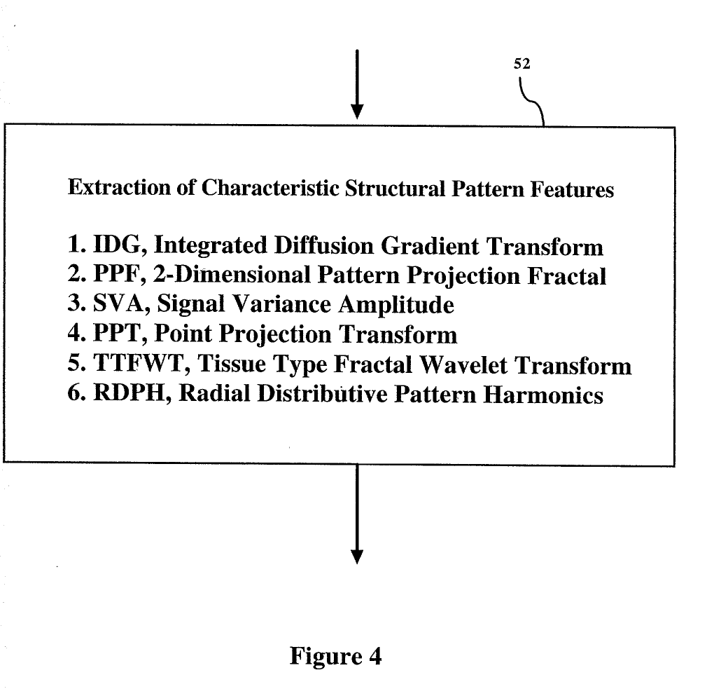

For an embodiment for recognition of tissue type and tissue structure type, as shown in FIG. 4, the methods employ procedures to compute six different characteristic form parameters for a window within each image 1 which generally is as large as the entire image. Such parameters computed from an image are often referred to as “features” that have been “extracted.” There are many different parameter (or feature) extraction (or computation) methods that would produce effective results for this expert system. In one embodiment, the parameter computations all compute measures of characteristic patterns across two or three spatial dimensions using intensity values with a precision of at least 6 significant bits for each pixel and including a measure of variance in the pixel intensities. One embodiment computes the six parameters described below. All six parameters contain information specific to the basic form of the physical tissue and cell structures as regards their statistical, distributive, and variance properties. .

1. IDG—Integrated Diffusion Gradient

The IDG transform procedure can be used to compute the basic ‘signal form response profile’ of structural patterns within a tissue/cell image. The procedure automatically separates type-specific signal structures by relative amplitude, spatial distribution, signal form and signal shape variance into a set of characteristic modes called the ‘characteristic form differentials’. These form differentials have been modeled as a set of signal form response functions which, when decoupled (for example, in a linear least-squares fashion) from the form response profile, represent excellent type recognition discriminators.

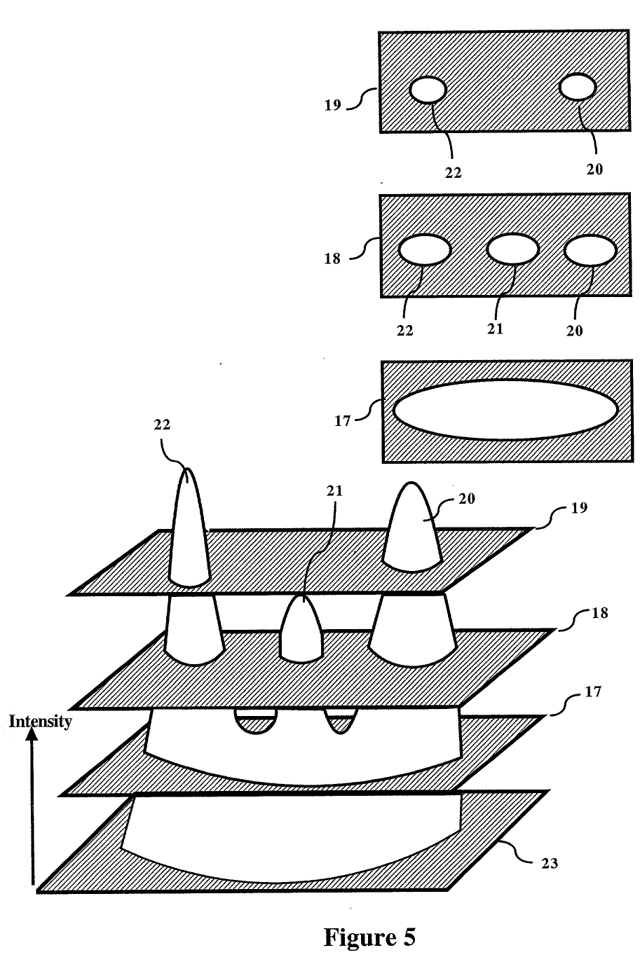

In summary, as shown in FIG. 5, the IDG for each window 23 (which, in one embodiment, is a small window 11-16 for nucleus recognition and is the entire image 1 for tissue or structure recognition) is calculated by examining the two dimensional spatial intensity distribution at different intensity levels 17-19 and computing their local intensity form differential variance. The placement of each level is a function of intensity amplitude in the window. FIG. 5 shows three intensity peaks 20-22, that extend through the first level 17 and the second level 18. Only two of them extend through the third level 19. For tissue recognition and structure recognition, in one embodiment, the computations are made at all intensity levels (256) for the entire image. For nuclei recognition in this embodiment, to save computation time, the computations are made at only 3 levels, as shown in FIG. 5, because there are a large number of objects 2-9 for each image and there are 6 sample windows 11-16 for each object.

In detail, in one embodiment, the IDG parameters are extracted from image data in the following manner:

(1) The pattern image data is fitted with a self-optimizing nth order polynomial fit, i.e., the chi-squared quality of fit is computed over n ranging from 2 to 5 and the order of the best fit is selected. This fit is used to define a flux-flow ‘diffusion’ surface for measurement of the characteristic form differential function. Depending on gain variances across the pattern, this diffusion surface can be warped (order of the fit greater than 2). This insures that, in this embodiment, the form differential measurements are always taken normal to the diffusion plane.

(2) The diffusion plane is positioned above the enhanced signal pattern and lowered one unit level at a time (dH). At each new position, the rate of change in the amount of signal structure passing through the plane is integrated and normalized by the number density (d(Si-1-Si)/d(Ni—I—Ni )=dNp ). The resulting function automatically separates type-specific signal structures by relative amplitude, signal strength distribution, signal form and signal shape variance into a function called the characteristic form differential (dNp/dH).

(3) The form differential is then low pass filtered to minimize the signal noise effects that are evidenced as random high frequency transient spikes superimposed on the primary function.

(4) Each of the peaks and valleys within the form differential function represent the occurrence of different signal components and the transition gradients between the structures are characteristic of the signal shape variance.

(5) In this embodiment, to obtain unique recognition parameters, the characteristic form differential is then decomposed into a linear superposition of these signal specific response profiles. This is accomplished by fitting the form differential function in a linear least-squares fashion, optimizing for (1) response profile amplitude, (2) extent as profile full-width-at-half-height (FWHH) and (3) their relative placement.

(6) Since signal strength is typically referenced to the background (or noise floor) levels, the response function fitting criteria can be used to determine the location of the background baseline as an added feature component (or for signal segmentation purposes). This can be accomplished by examining the relative change in the response profile measures over the entire dNp/dH function to identify the onset of the signal baseline as the diffusion surface is lowered. From this analysis, the bounding signal responses and the signal baseline threshold (THD) are computed.

For tissue and structure recognition, the IDG transform extracts 256 form differentials which are then fitted with 8 characteristic response functions. Location of each fit is specified with one value and the amplitude is specified with a second value, making 16 total values. Along with two baseline parameters, which are the minimum for the 256 point curve and the area under the curve, this generates an input vector of 18 input values for the neural network.

2. PPF—Two-Dimensional Pattern Projection Fractal

The PPf can be computed by projecting the tissue/cell segmentation signals into a 2-dimensional binary point-pattern distribution. This distribution is then subjected to an analysis procedure that maps the clustered distributions of the projection over a broad range of sampling intervals across the segmented image. The sample measurement is based on the computation of the fractal probability density function.

PPF focuses on the fundamental statistical and distributive nature of the characteristic aspects of form within tissue samples. It is based on a technique that takes advantage of the naturally occurring properties of tissue patterns that exhibit spatial homogeneity (invariance under displacement), scaling (invariance under moderate scale change) and self-similarity (same basic form throughout), e.g., characteristics of basic fractal form; with different tissue/cell structural patterns having unique fractal forms. The mix of tissue cell types and the way they are distributed in the tissue type provides unique differences in the imaged tissue structures.

In one embodiment, the measurement of the PPF parameter is implemented as a form of the computation of the fractal probability density function using new procedures for the generation of a point-pattern projection and variant magnification sampling. Further signal segmentation comprises an analysis of the 2-dimensional distributive pattern of the imaged intensity profile, segmented when the optimum contrast image is computed employing principal component analysis, fitted with an nth order polynomial surface and then binarized to generate a positive residual projection.

(1) The segmented pattern data is signal-gain (intensity) de-biased. This can be accomplished by iteratively replacing each pixel value within the pattern image with the minimum localized value defined within an octagonal area between about 5 and 15 pixels across. This results in a pattern that is not changed as regards uniformity or gradual variance. However, regions of high variance, smaller than the radius of the region of interest (ROI), are reduced to the minimum level of the local background.

(2) The pattern image is then fitted with a self-optimizing nth order polynomial fit, i.e., the chi-squared quality of fit is computed over n ranging from 2 to 5 and the order of the best fit is selected. This fit is then used to compute the positive residual of the patterned image and binarized to generate a point pattern distribution.

(3) The measurement of the fractal probability density function is accomplished by applying the radial-density distribution law, d=Cr(D⁻²), where d is the density of tissue/cell pattern points at a given location, C is a constant, r is the distance from the center of a cluster and D is the Hausdorff fractal dimension. Actual computation of the fractal dimension is accomplished using a box-counting procedure. Here, a grid is superimposed onto the tissue point pattern image and the number of grid boxes containing any part of the fractal pattern are counted. The size of the box grid is then increased and the process is iteratively repeated until the pattern sample size limits the number of measurements. If the number of boxes in the first and last grids are G1 and G2, and the counts are C1 and C2, then the Hausdorff dimension CAN BE DETERMINED by the formula, D=log(number of self-similar occupied pieces)/log(magnification factor), or in this case D=log(C2/C1)/log(sqrt(G2/G1)).

(4) Extraction of the PPF feature set CAN BE accomplished by computing the Hausdorff dimension for multiple overlapping regions of interest (ROIs) that span the entire image domain with additional phased samplings varying in ROI scale size. Depending on the tissue type, the ROI's CAN BE selected to be 128 pixels by 128 pixels or 256 pixels by 256 pixels. IN THIS EMBODIMENT, the result is 240 individual fractal measurements of the tissue/cell point distribution pattern with a sampling cell magnification varying from 0.156 to 1.0.

The PPF algoritm extracts 240 different phased positional and scaled fractal measurements, generating an input vector of 240 input values to the neural networks.

3. SVA—Signal Variance Amplitude

The SVA procedure involves the separation of a tissue/cell color image into three (3) RGB multi-spectral bands which then form the basis of a principal components transform. The covariance matrix CAN BE computed and diagonalized to determine the eigenvectors, a set of de-correlated planes ordered by decreasing levels of variance as a function of ‘color-clustered’ signal strengths. This procedure for the 2-dimensional tissue/cell patterns represents a rotational transform that maps the tissue/cell structural patterns into the signal variance domain. As such, the resultant 3×3 re-mapping diagonalized matrix and its corresponding relative eigenvector magnitudes form the basis of a characteristic statistical variance parameter set delineating tissue cell signals, nuclei and background signatures.

This procedure represents a rotational transform that maps the tissue/cell structural patterns into the signal variance domain. The principal component images (E1, E2, E3) are therefore uncorrelated and ordered by decreasing levels of signal variance, E.G., E1 has the largest variance and E3 has the lowest. The result is the removal of the correlation that was present between the axes of the original RGB spectral data with a simultaneous compression of pattern variance into fewer dimensions.

For tissue/cell patterns, the principal components transformation represents a rotation of the original RGB coordinate axis to coincide with the directions of maximum and minimum variance in the signal (pattern specific) clusters. On subtraction of the mean, the re-mapping shifts the origin to the center of the variance distribution with the distribution about the mean being multi-modal for the different signal patterns (E.G., cell, nuclei, background) within the tissue imagery.

Although the principal components transformation does not specifically utilize any information about class signatures, the canonical transform does maximize the separability of defined signal structures. Since the nature of the stains is specific to class species within a singular tissue type, this separability correlates directly with signal recognition.

The parameter sets are the resultant 3×3 re-mapping diagonalization matrix and its corresponding relative eigenvector magnitudes. The SVA algorithm extracts 9 parameters derived from the RGB color 3×3 diagonalization matrix, generating an input vector of 9 input values to the neural networks.

4. PPT—Point Projection Transform

The PPT descriptor extraction procedure is based on the transformation of the tissue/cell structural patterns into a polar coordinate form (similar to the Hough Transform, x cos 0+y sin 0=r) from the unique basis of a linearized patterning of a tissue/cell structural signal. This linearization projection procedure reduces the dynamic range of the tissue/cell signal segmentation while conserving the structural pattern distributions. The resultant PPT computation then generates a re-mapped function that is constrained by the requirement of “conservation of the relative spatial organization” in order conserve a true representation of the image content of the original tissue/cell structure. By way of further signal segmentation, parameter extraction is based on analysis of the 2-dimensional distributive line-pattern of the imaged intensity profile, segmented when the optimum contrast image is computed employing principal component analysis, fitted with an nth order polynomial surface, binarized to generate a positive residual projection and then subjected to 2-dimensional linearization procedure that forms a line drawing equivalent of the entire tissue image.

In one embodiment, the first two steps of the PPT parameter calculation algorithm are the same as for the PPF parameter, above. The method then continues as follows:

(3) The binarized characteristic pattern is then subjected to a selective morphological erosion operator that reduces regions of pixels into singular points along median lines defined within the method as the projection linearization of form. This is accomplished by applying a modified form of the standard erosion kernel to the residual image in an iterative process. Here the erosion operator has been changed to include a rule that considers the occupancy of nearest neighbors, E.G., if a central erosion point does not have connected neighbors that form a continuous distribution, the point cannot be removed. This process reduces the projection into a linearized pattern that contains significant topological and metric information based on the numbers of end points, nodes where branches meet and internal holes within the regions of the characteristic pattern.

(4) The methodS compute actual PPT features by mapping the linearized pattern from a Cartesian space into a polar form using a modified Hough Transform that employs a masking algorithm that bounds the selection of Hough accumulation cells into specific ranges of slope and intercept.

The PPT algorithm extracts 1752 parameters from the Hough transform of the line drawing of the two dimensional tissue intensity image, generating an input vector of 1752 input values to the neural networks.

5. TTFWT—Tissue Type Fractal Wavelet Transform

The mix of cell types along with their distributions provides imaged tissue structural form. Within tissue/cell structural patterns, characteristic geometrical forms CAN represent fractal primitives and form the basis for a set of mother-wavelets employable in a multi-dimensional wavelet decomposition. The TTFWT parameter extraction procedure extracts a fractal representation of the tissue/cell structural patterns via a discrete wavelet transform (DWT) based on the mappings of self-similar regions of a tissue/cell signal pattern image using the shape of the IDG characteristic form differentials as the class of mother-wavelets. Parameter extraction is based on the re-sampling and integration of the multi-dimensional wavelet decomposition on a radial interval to generate a characteristic waveform containing elements relative to the fractal wavelet coefficient densities. . In one embodiment, the procedure includes the following steps:

(1) The image pattern is resized and sampled to fit on a 2^{N} interval, for example as a 512×512 or 1024×1024 image selected from the center of the original image.

(2) A characteristic mother wavelet (fractal form) is defined by a study of signal type-specific structures relative to amplitude, spatial distribution, signal form and signal shape variance in a statistical fashion across a large set of tissue/cell images under the IDG procedures previously discussed.

(3) The re-sampled image is then subjected to a 2-dimensional wavelet transform using the uniquely defined fractal form mother wavelet.

(4) To generate the characteristic features, the 2-dimensional wavelet transform space is then sampled and integrated on intervals of wavelet coefficient (scaling and translation intervals) and renormalized on unit area. These represent the relative element energy densities of the transform.

The TTFWT algorithm generates an input vector of 128 input values to the neural networks.

6. RDPH—Radial Distributive Pattern Harmonics

The RDHP parameter extraction procedure is designed to enhance the measurement of the local fractal probability density functions (FPDFs) within tissue/cell patterns on a sampling interval which is rotationally and scaling invariant. The procedure builds on the characteristic of local self-similarities within tissue/cell imagery. Image components can be seen as re-scaled with intensity transformed mappings yielding a self-referential distribution of the tissue/cell structural data. Implementation involves the measurement of a series of fractal dimensions measured across two spatial dimensions (based on range dependent signal intensity variance) on a centered radial 360 degree scan interval. The resulting radial fractal probability density curve is then normalized and subjected to a Polar Fourier Transform to generate a set of phase invariant parameters.

By way of further signal segmentation, parameter extraction is based on analysis of the 2-dimensional distributive de-biased pattern of the imaged intensity profile, segmented when the optimum contrast image is computed employing principal component analysis with regions of high variance being reduced to the minimum level of the local background generating a signal-gain (intensity) de-biased image.

In one embodiment, the first step of the RDPH parameter calculation algorithm is the same as for the PPF parameter, above. The method then continues as follows:

(2) The enhanced pattern is then signal-gain (intensity) de-biased. This is accomplished by iteratively replacing each pixel value within the enhanced pattern image with the minimum localized value defined within an octagonal region-of-interest (ROI). This results in a pattern that is not changed as regards uniformity or gradual variance. However regions of high variance, smaller than the radius of the ROI, are reduced to the minimum level of the local background.

(3) In this embodiment, on a radial scan sampling, a set of 360 profiles are generated from a centered analysis scheme within the de-biased image. For binary type tissue/structure patterns where the pixel values are simplified to black or white, this represents the measurement of the occupation density on a unit radial interval bounded by image size constraints. For continuous grayscale patterns, the profiles represent area integrated signal intensities.

(4) The fractal dimension of each of the angle-dependent profiles is computed.

(5) In radial form, the fractal measurements are normalized to unit magnitude to remove scale dependence. The function is then operated on by a polar Fourier transform (PFT) to generate a set of polar harmonics with each component above the zero order representing increasing degree of deviation from circular form. These represent the RDPH parameter set.

The RDPH algorithm extracts 128 parameters from the polar-fourier transform of the 360 2-dimensional distribution dependent fractal dimension measurements, generating an input vector of 128 input values to the neural networks.

Tissue/Structure/Nucleus Recognition

One embodiment of the systems and methods has been structured to meet three primary design specifications. These are: (1) the ability to handle high-throughput automated classification of tissue and cell structures, (2) the ability to generate correlated assessments of the characteristic nature of the tissue/cell structures being classified and (3) the ability to adaptively extend trained experience and provide for self-expansive evolutionary growth.

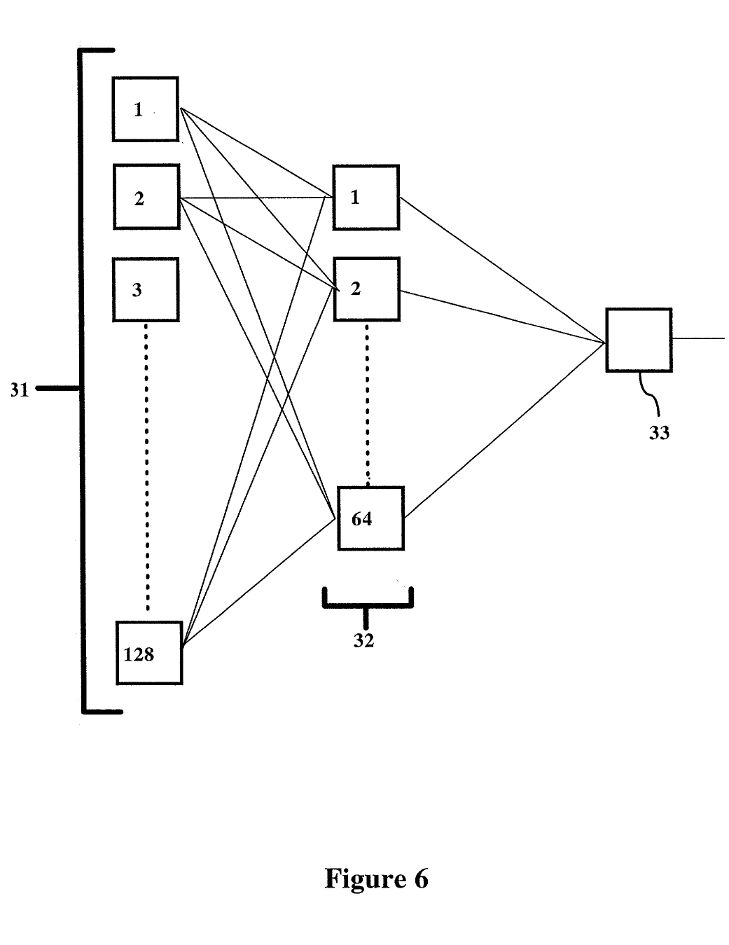

Achievement of these design criteria has been accomplished through the use of an association decision matrix that operates on the outputs of multiple neural networks. FIG. 6 shows one of the neural networks. As described above, several of the parameter computation processes yield a set of 128 values which are the inputs to feed the 128 input nodes 31 of a neural network. Others of the parameter computations require other numbers of input nodes. For each neural network, a second layer has half as many neurons. For example, the network shown in FIG. 6 has 64 neurons 32 in a second layer and a singular output neuron 33. Each of these neural networks may be comprised of subnetworks as further described below.

Each network can be trained to classify the image into one of many classes as is known. In this case, each network is trained on all the classes.

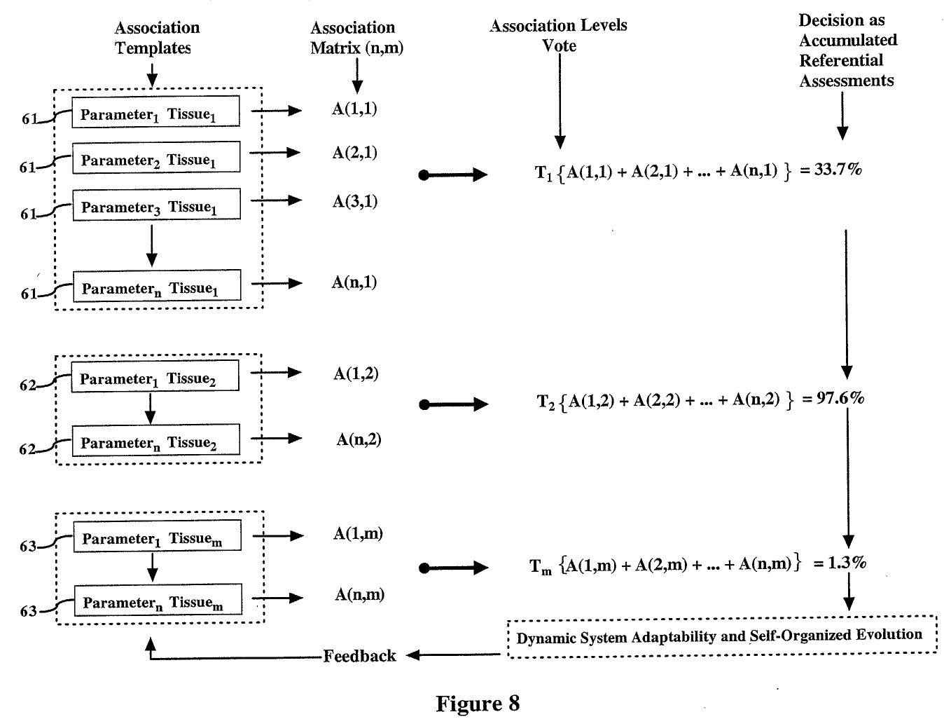

Instead, in another embodiment, each network is trained on only one pattern and is designed to return a level of associative recognition ranging from 0, as totally unlike, to 1, as completely similar. In this case, the network is trained on only two classes of images, those that show the sought material and others like them expected within the image to be analyzed that do not. The output of each network is a probability value, expressed as 0-1, that the material in the image is the item on which the network was trained. For output to a human, the probability may be restated as a percent as shown in FIG. 8. The outputs of the many neural networks are then aggregated to yield a single most probable determination.

Thus, each neural network compares the input vector (parameter) to a “template” that was created by training the network on a single pattern with many images of that pattern. Therefore, a separate network is used for each pattern to be recognized. If a sample is to be classified into one of 50 tissue types, 50 networks are used. The networks can be implemented with software on a general purpose computer, and each of the 50 networks can be loaded on a single computer in series for the computations. Alternatively, they can be run simultaneously on 50 computers in parallel, or otherwise as desired.

In one configuration of the neural networks, a systems analysis, from acquisition to feature extraction, can be used to identify different sources of data degradation variance within the tissue processing procedures and within the data acquisition environment that influence the ability to isolate and measure characteristic patterns. These sources of data degradation can be identified by human experience and intuition. Because these sources generally are not independent, they typically cannot be linearly decoupled, removed or separately corrected for.

Identified modal aspects of data degradation include (1) tissue processing artifacts such as stain type, stain application method, multiple stain interference/obscuration and physical tissue quality control issues, (2) data acquisition aspects relating to microscope imaging aberrations such as spherical and barrel distortions, RGB color control, pixel dynamic range and resolution, digital quantization, and aliasing effects, (3) systematic noise effects and pattern measurement variance based on statistical sampling densities, and (4) effects from undesirable variation in level of stain applied. In one embodiment, these are grouped into 7 categories.

To compensate for these variance-modes of data degradation and enhance recognition ability, one embodiment employs for each neural network a set of eight different subnetworks that each account for a different systematic variance aspect (mode): seven individual modes and one composite mode. Each subnetwork processes the same input pattern vector, but each subnetwork has been trained on data that demonstrate significant effects specific to a different variance-mode and its relative coupling to other modal data degradation aspects. This processing architecture is one way to provide the association-decision matrix with the ability to dampen and minimize the level of loss in recognition based on obscuration of patternable form from tissue preparation, data acquisition, and other artifacts, interference, or noise, by directly incorporating recognition of the inherent range of artifacts in an image.

In one embodiment, a human can select images of known content showing the desired data degradation effects and train a subnetwork with images that show the characteristic source of data degradation. The eighth subnetwork can be trained with all or a subset of the images. For each image, the subnetwork can be instructed whether the image shows the type of tissue or structure or nuclei for which the network is being trained.

Recognition of Nuclei

For recognition of nuclei, in some embodiments, only the IDG parameter is used for each nucleus or clump and only one neural network is used for comparison to each recognition “template” (although that network may include a subnet for each data degradation mode). For example, for cancerous neoplasia only one neural net is required, but it can still have 8 subnets for data degradation modes.

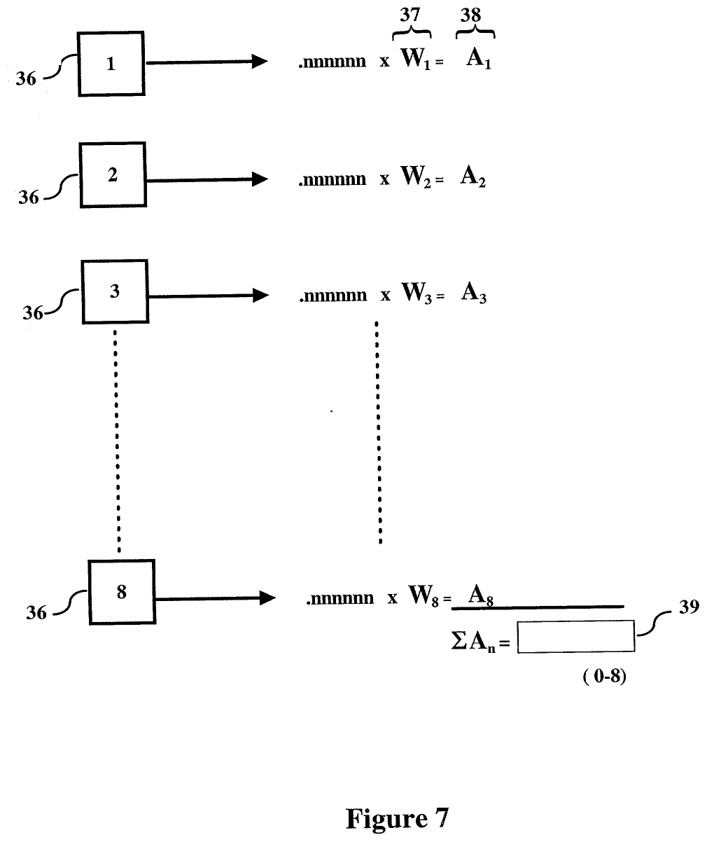

For example, for recognition of nuclei, the IDG parameter yields a set of 128 values for each of the 8 subnetworks and there are 8 outputs 33 from the subnetworks. These 8 outputs are applied as inputs 36 to an associative voting matrix as shown in FIG. 7. Each of the inputs may be adjusted with a weighting factor 37. The present system uses weights of one; other weights can be selected as desired. The weighted numbers 38, with a range of association levels from 0 to 1, are added to produce a final number 39 between, in this embodiment, 0 and 8. This sum of modal association levels is called the association matrix vote. A vote of 4.0 or greater is considered to be positive recognition of the nucleus type being tested for.

Recognition of nuclei can typically determine not only whether a nucleus appears abnormal, but also the cell type. A list of normal cell types that can be identified by the signature of their nuclei, along with a list of the tissues, tissue structures, and sub-structures that can be recognized is shown in Table 2, below.

Abnormal cell types suitable for use with the present invention include, for example, the following four categories:

(1) Neoplastic and Proliferative Diseases

The altered nuclear characteristics of neoplastic cells and their altered growth arrangements allow the method to identify both benign and malignant proliferations, distinguish them from the surrounding normal or reactive tissues, distinguish between benign and malignant lesions, and identify the invasive and pre-invasive components of malignant lesions.

Examples of benign proliferative lesions include (but are not necessarily limited to) scars, desmoplastic tissue reactions, fibromuscular and glandular hyperplasias (such as those of breast and prostate); adenomas of breast, respiratory tract, gastrointestinal tract, salivary gland, liver, gall bladder, endocrine glands; benign growths of soft tissues such as fibromas, neuromas, neurofibromas, meningiomas, gliomas, and leiomyomas; benign epitehlial and adnexal tumors of skin, benign melanocytic nevi; oncocytomas of kidney, and the benign tumors of ovarian surface epithelium.

Examples of malignant tumors suitable for use with the methods, systems, and the like discussed herein, in either their invasive and preinvasive phases, both at a primary site and at a site to which they have metastasized, are listed in following Table 1.

TABLE 1
Neoplastic and Proliferative Diseases

| | |
|---|---|
| Adrenal | pheochromocytoma |
| | neuroblastoma |
| Blood vessels | hemangiosarcoma |
| | lymphangiosarcoma |
| | Kaposi's sarcoma |
| Bone | osteosarcoma |
| | chondrosarcoma |
| | giant cell tumor |
| | osteoid osteoma |
| | enchondroma |
| | chondromyxoid fibroma |
| | osteoblastoma |
| Bone marrow & Spleen | chronic lymphocytic leukemia |
| | acute lymphoblastic leukemia |
| | multiple myeloma |
| | acute myelogenous leukemia |
| | chronic myelogenous leukemia |
| | hairy cell leukemia |
| Breast | invasive carcinoma |
| | carcinoma in situ |
| | ductal carcinoma |
| | lobular carcinoma |
| | medullary carcinoma |
| | adenoma |
| | adenofibroma |
| | epithelial hyperplasia |
| | phyllodes tumors |
| Cervix | squamous carcinoma |
| | malignant melanoma |
| Colon | invasive colorectal carcinoma |
| | non-invasive carcinomas |
| | adenomas |
| | dysplasias |
| Esophagus | squamous carcinoma |
| | non-invasive carcinoma |
| | dysplasia |
| | malignant melanoma |
| Eye | retinoblastoma |
| Kidney | invasive renal cell carcinoma |
| | Wilm's tumor |
| Liver & Biliary | hepatocellular carcinoma |
| | cholangiocarcinoma |
| | pancreatic carcinoma |
| | carcinoid and islet cell tumor |
| Lung | small cell carcinoma |
| | non-small cell carcinoma |
| | mesothelioma |
| | squamous carcinoma of bronchus |
| | non-invasive carcinoma of bronchus |
| | dysplasia of bronchus |
| | malignant melanoma of bronchus |
| Lymph node | non-Hodgkin's lymphoma |
| | Hodgkin's lymphoma |
| Muscle | rhabdomyosarcoma |
| | leiomyoma |
| | leiomyosarcoma |
| Nervous | schwannoma |
| | neurofibroma |
| | neuroblastoma |
| | glioblastoma |
| | ependymoma |
| | oligodendroglioma |
| | astrocytoma |
| | medulloblastoma |
| | ganglioneuroma |
| | memngioma |
| Oral and nasal | squamous carcinoma |
| | non-invasive carcinoma |
| | dysplasia |
| | malignant melanoma |
| Ovary | invasive carcinoma |
| | borderline epithelial tumors |
| | germ cell tumors |
| | stromal tumors |
| Prostate | invasive carcinoma |
| | intraepithelial neoplasia |
| | benign prostatic hyperplasia |
| Salivary gland | pleomorphic adenoma & mixed tumor |
| | mucoepidermoid tumor |
| | adenoid cystic carcinoma |
| Skin | malignant melanoma |
| | squamous carcinoma |
| | non-invasive carcinoma |
| | dysplasia |
| | adnexal tumors |
| | dermatofibroma |
| | basal cell carcinoma |
| | keratoacanthoma |
| | nevi |
| | mycosis fungoides |
| | seborrheic keratosis |
| | warts |
| | lentigo and melanocytic |
| Stomach | gastric carcinoma |
| | Barrett's esophagus |
| Testis | germ cell tumors |
| | seminoma |
| | Leydig and Sertoli cell tumors |
| Thyroid | papillary carcinoma |
| | follicular carcinoma |
| | medullary carcinoma |
| Urinary tract | urothelial carcinoma |
| Uterus | endometrial carcinoma |
| | leimyoma and leiomyosarcoma |
| | mixed tumors |
| | mesenchymal tumors |
| | gestational trophoblastic disease |
| | squamous carcinoma |
| | non-invasive carcinoma |
| | dysplasia |
| | malignant melanoma |
| Vagina | squamous carcinoma |
| | non-invasive carcinoma |
| | dysplasia |
| | malignant melamoma |
| Soft tissues | chondrosarcoma |
| | malignant fibrous hystiocytoma |
| | lipoma |
| | liposarcoma |
| | synovial sarcoma |
| | fibrosarcoma |
| | stromal tumors |

(2) Infectious, Inflammatory and Autoimmune Diseases:

The method can be used to identify diseases that involve the immune system, including infectious, inflammatory and autoimmune diseases. In these diseases, inflammatory cells become activated and infiltrate tissues in defined populations that contain characteristics that can be detected by the method, as well as producing characteristic changes in the tissue architecture that are a consequence of cell injury or repair within the resident cell types that are present within the tissue. Inflammatory cells include neutrophils, mast cells, plasma cells, immunoblasts of lymphocytes, eosinophils, histiocytes, and macrophages.

Examples of inflammatory diseases include granulomatous diseases such as sarcoidosis and Crohn's colitis, bacterial, viral, fungal or other organismal infectious diseases such as tuberculosis, helicobacter pylori induced ulcers, meningitis, and pneumonia. examples of allergic diseases include asthma, allergic rhinitis (hay fever), and celiac sprue, autoimmune diseases such as rheumatoid arthritis, psoriasis, Type I diabetes and ulcerative colitis, multiple sclerosis, hypersensitivity reactions such as transplant rejection, and other such disorders of the immune system or inflammatory conditions (such as endocarditis or myocarditis, glomerulonephritis, pancreatitis, bronchitis, encephalitis, thyroiditis, prostatitis, gingivitis, cholecystitis, cervicitis, thyroiditis or hepatitis) that produce characteristic patterns involving the presence of infiltrating immune cells or alterations to existing cell types that are features of such diseases. Atherosclerosis, which involves the presence of inflammatory cells and characteristic architectural changes within cells of the arterial lining and wall, can also be recognized by this method.

(3) Degenerative Diseases and Anoxic or Chemical Injury

The method is useful for detecting diseases that involve the loss of particular cell types, or the presence of injured and degenerating cell types. Examples of neurodegenerative diseases include as Alzheimer's disease, Parkinson's disease and amyotrophic lateral sclerosis, which involve the loss of neurons and characteristic changes within injured neurons. Examples of diseases that involve injury to cell types by ischemic insult (loss of blood supply) include stroke, myocardial infarct (heart attack), thrombotic or embolic injury to organs. Examples of diseases that involve loss or alteration of particular cell types include osteoarthritis in joints. Examples of chronic forms of injury include hypertension, cirrhosis and heart failure. Examples of chemical or toxic injuries that produce characteristics of cell death INCLUDE acute tubular necrosis of the kidney. Examples of aging within organs include aging in the skin and hair.

(4) Metabolic and Genetic Diseases

Certain genetic diseases also produce characteristic changes in cell populations that can be recognized by this method. Examples of such diseases include cystic fibrosis, retinitis pigmentosa, neurofibromatosis, and storage diseases such as Gaucher's and Tay-Sachs. Examples of diseases that produce characteristic alterations in the bone marrow or peripheral blood cell components include anemias or thrombocytopenias.

Recognition of Tissues and Structures

In some embodiments, a desired set of images of known tissue/structure types is subjected to the parameter extractions described above and separate associative class templates are generated using artificial neural networks for use, not as classifiers into one of many classes but as structural pattern references to a single template for the tissue or structure to be recognized. These references indicate the ‘degree of similarity’ between the reference and a test tissue or structure and may simultaneously estimate the recognition probability (level of confidence). Each network then contributes to the table of associative assessments that make up the ‘association matrix’ as shown in FIG. 8. In the embodiment depicted in FIG. 8, there is a separate subnet 61-63 with a specific template for each parameter for each tissue or structure to be recognized. So, as shown in FIG. 8, for recognition of tissue type 1 there are n subnets 61, one for each parameter. Likewise, for tissue type 2 there are n subnets 62, and for tissue type m there are n subnets 63. As discussed above, each of these subnets can be comprised of additional subnets, for example one for each mode of data degradation in the training set.

By this method, the system can recognize with sufficient certainty to be useful many of the the same tissue types and structures that can be recognized by a pathologist with a microscope, including those in Table 2 below. In operation of the system, there is no functional difference between a structure and a substructure. They are both recognized by the same methods. A substructure is simply a form that is found within a larger structure form. However, because this relative hierarchy is used by pathologists and allows the following table to be more compact, this relative hierarchy is shown in the following Table 2, which also lists normal cell types.

TABLE 2
Tissues, Structures, Sub-Structures, and Normal Cell Types

| | | SUB- | |
|---|---|---|---|
| TISSUE | STRUCTURE | STRUCTURE | CELL |
| adrenal | Cortex | zona fasciculata | spongiocyte |
| adrenal | Cortex | zona glomerulosa | |
| adrenal | Cortex | zona reticularis | |
| adrenal | medulla | | chromaffin cell |
| adrenal | medulla | | ganglion cell |
| artery | Tunica adventitia | | adipocytes |
| artery | Tunica adventitia | vasa vasorum | endothelial cell |
| artery | Tunica adventitia | | fibroblast |
| artery | Tunica adventitia | nerve | Schwann cell |
| artery | Tunica adventitia | vasa vasorum | smooth muscle cell |
| artery | Tunica intima | | endothelial cell |
| artery | tunica intima | | myointimal cell |
| artery | tunica media | | smooth muscle cell |
| artery | tunica media | external elastic | |
| | | lamella | |
| artery | tunica intima | internal elastic | |
| | | lamella | |
| bladder | mucosa | | transitional cell |
| bladder | muscularis | | smooth muscle cell |
| bone | periosteum | | osteoprogenitor cell |
| bone | matrix | | |
| bone | perisoteum | | |
| bone | | | osteoblast |
| bone | | | osteoclast |
| bone | | | osteocyte |
| bone | | | osteoid |
| bone | | cartilage | chondrocyte |
| bone marrow | | | adipocyte |
| bone marrow | | | eosinophil |
| bone marrow | | | erythrocyte |
| bone marrow | | | granulocyte |
| bone marrow | | | lymphocyte |
| bone marrow | | | macrophage |
| bone marrow | | | mast cell |
| bone marrow | | | megakaryocyte |
| bone marrow | | | monomyelocyte |
| bone marrow | | | neutrophils |
| bone marrow | | | plasma cell |
| brain | cerebellum | molecular layer | basket cell neuron |
| brain | cerebellum | granular layer | Golgi type II cell |
| brain | cerebellum | Purkinje cell layer | Purkinje cell |
| brain | cerebellum | molecular layer | stellate cell neuron |
| brain | choroid plexus | | choroid plexus cell |
| brain | ependyma | | ependymal cell |
| brain | gray matter | | astrocyte |
| brain | gray matter | | microglial cell |
| brain | gray matter | | neuron |
| brain | gray matter | | satellite |
| | | | oligodendrocyte |
| brain | hippocampus | CA1 | neuron |
| brain | hippocampus | CA2 | neuron |
| brain | hippocampus | CA3 | neuron |
| brain | hippocampus | CA4 | neuron |
| brain | hippocampus | dentate gyrus | neuron |
| brain | hippocampus | parahippocampus | neuron |
| brain | hypothalamus | paraventricular n. | neuron |
| brain | hypothalamus | supraoptic n. | neuron |
| brain | hypothalamus | ventromedial n. | neuron |
| brain | hypothalamus | dorsomedial n. | neuron |
| brain | hypothalamus | arcuate n. | neuron |
| brain | hypothalamus | periventricular | neuron |
| | | zone | |
| brain | meninges | | meningothelial cell |
| brain | meninges | | mesothelial cell |
| brain | substantia nigra | | dopaminergic |
| | | | neuron |
| brain | white matter | | astrocyte |
| brain | white matter | | microglial cell |
| brain | white matter | | oligodendrocyte |
| brain | cerebellum | granular layer | granule cell neuron |
| brain | neuropil | | |
| brain | basal forebrain | nucleus basalis | neuron |
| breast | duct | | epithelial cell |
| breast | duct | | myoepithelial cell |
| breast | lobule | | epithelial cell |
| breast | lobule | | myoepithelial cell |
| breast | nipple | lactiferous duct | epithelial cell |
| bronchus | cartilage | | chondrocytes |
| bronchus | mucosa | | basal mucosal cell |
| bronchus | mucosa | | ciliated cell |
| bronchus | mucosa | | goblet cell |
| bronchus | submucous gland | | mucous gland cell |
| bronchus | submucous gland | | seromucous gland |
| | | | cell |
| bronchus | cartilage | matrix | |
| bronchus | cartilage | perichondrium | |
| colon | Auerbach's | | ganglion cell |
| | plexus | | |
| colon | Auerbach's | | Schwann cell |
| | plexus | | |
| colon | lamina propria | vessel | endothelial cell |
| colon | lamina propria | | lacteal endothelial |
| | | | cell |
| colon | lamina propria | | lymphocyte |
| colon | lamina propria | | macrophage |
| colon | lamina propria | | plasma cell |
| colon | lamina propria | vessel | smooth muscle cell |
| colon | Meissner's plexus | | ganglion cell |
| colon | Meissner's plexus | | Schwann cell |
| colon | mucosa | | enterocyte |
| colon | mucosa | | goblet cell |
| colon | mucosa | | neuroendocrine cell |
| colon | mucosa | | paneth cell |
| colon | muscularis | | smooth muscle cell |
| | mucosa | | |
| colon | muscularis | | smooth muscle cell |
| | propria | | |
| colon | nerve | | Schwann cell |
| colon | Peyer's patches | | dendritic cell |
| colon | Peyer's patches | | lymphocyte |
| colon | serosa | | adipocytes |
| colon | serosa | | fibroblast |
| colon | serosa | | mesothelial cell |
| colon | submucosa | vessel | endothelial cell |
| colon | submucosa | | fibroblast |
| colon | submucosa | vessel | smooth muscle cell |
| duodenum | mucosa | crypt of | columnar cell |
| | | Lieberkuhn | |
| duodenum | mucosa | | goblet cell |
| duodenum | mucosa | | lacteal endothelial |
| | | | cell |
| duodenum | mucosa | crypt of | neuroendocrine cell |
| | | Lieberkuhn | |
| duodenum | mucosa | crypt of | paneth cell |
| | | Lieberkuhn | |
| duodenum | mucosa | | surface absorptive |
| | | | cell |
| duodenum | muscularis | Auerbach's | ganglion cell |
| | | plexus | |
| duodenum | muscularis | Auerbach's | Schwann cell |
| | | plexus | |
| duodenum | serosa | | fibroblast |
| duodenum | submucosa | Brunner's glands | epithelial cell |
| duodenum | submucosa | Meissner's plexus | ganglion cell |
| duodenum | submucosa | Meissner's plexus | Schwann cell |
| ear | auricle | cartilage | chondrocytes |
| ear | auricle | epidermis | keratinocyte |
| ear | external | cartilage | chondrocytes |
| ear | external | ceruminous gland | gland epithelial |
| | | | cell |
| ear | external | epidermis | keratinocyte |
| ear | inner | organ of Corti | cell of Boettcher |
| ear | inner | organ of Corti | cell of Claudius |
| ear | inner | organ of Corti | cell of Hensen |
| ear | inner | cochlear duct | epithelial cell |
| ear | inner | maculae of utricle | hair cell |
| | | and saccule | |
| ear | inner | crista ampullaris | hair cell |
| ear | inner | organ of Corti | inner hair cell |
| ear | inner | organ of Corti | inner phalangeal |
| | | | cell |
| ear | inner | organ of Corti | inner pillar cell |
| ear | inner | organ of Corti | inner sulcus cell |
| ear | inner | semicircular canal | neuroepithelial hair |
| | | | cell |
| ear | inner | organ of Corti | outer hair cell |
| ear | inner | organ of Corti | outer phalangeal cell |
| ear | inner | organ of Corti | outer pillar cell |
| ear | inner | spiral ganglion | pseudounipolar cell |
| ear | inner | organ of Corti | stria vascularis |
| | | | epithelial cell |
| ear | inner | maculae of utricle | supporting cell |
| | | and saccule | |
| ear | inner | crista ampullaris | sustentacular cell |
| ear | middle | | cuboidal epithelial |
| | | | cell |
| ear | middle | malleus | osteocyte |
| ear | middle | incus | osteocyte |
| ear | middle | stapes | osteocyte |
| ear | tympanic | inner | cuboidal epithelial |
| | membrane | | cell |
| ear | tympanic | outer | squamous epithelial |
| | membrane | | cell |
| ear | semicircular canal | cupula | |
| ear | crista ampullaris | cupula | |
| ear | vestibulocochlear | nerve fiber | |
| | nerve | | |
| ear | facial nerve | nerve fiber | |
| ear | maculae | otolith | |
| epididymis | | | epithelial cell |
| epididymis | | | smooth muscle cell |
| epididymis | | | spermatozoa |
| esophagus | mucosa | | squamous epithelial |
| | | | cell |
| esophagus | muscularis | | skeletal muscle cell |
| | externa | | |
| esophagus | muscularis | | smooth muscle cell |
| | externa | | |
| esophagus | muscularis | | smooth muscle cell |
| | mucosa | | |
| esophagus | serosa | | fibroblast |
| esophagus | submucosa | esophageal gland | epithelial cell |
| eye | ciliary body | | cililary muscle cell |
| eye | ciliary body | inner | nonpigmented |
| | | | epithelial cell |
| eye | ciliary body | outer | pigmented epithelial |
| | | | cell |
| eye | conjunctiva | | conjunctival |
| | | | epithelial cell |
| eye | cornea | Bowman's | epithelial cell |
| | | membrane | |
| eye | cornea | | corneal endothelial |
| | | | cell |
| eye | cornea | Descemet's | epithelial cell |
| | | membrane | |
| eye | cornea | | fibroblast |
| eye | cornea | | lymphoid cell |
| eye | cornea | | simple cuboidal |
| | | | epithelial cell |
| | | | (posterior) |
| eye | cornea | | simple squamous |
| | | | epithelial cell |
| | | | (posterior) |
| eye | cornea | | stratified squamous |
| | | | nonkeratinized |
| | | | epithelial cell |
| | | | (anterior) |
| eye | fovea | | ganglion cell |
| eye | fovea | | pigmented epithelial |
| | | | cell |
| eye | iris | | iris pigmented cell |
| eye | iris | | myoepithelial cell |
| eye | iris | | pigment cell |
| eye | iris | | pigmented epithelial |
| | | | cell |
| eye | iris | | smooth muscle cell |
| eye | lens | | lens epithelial cell |
| eye | lens | lens fibers | |
| eye | retina | | cone cell |
| eye | retina | | ganglion cell |
| eye | retina | | pigment epithelial |
| | | | cell |
| eye | retina | | rod cell |
| eye | retina | ganglion cell | |
| | | layer | |
| eye | retina | inner nuclear | |
| | | layer | |
| eye | retina | inner plexiform | |
| | | layer | |
| eye | sclera | | melanocyte |
| eye | fovea | external limiting | |
| | | membrane | |
| eye | fovea | ganglion cell | |
| | | layer | |
| eye | fovea | inner limiting | |
| | | membrane | |
| eye | fovea | lamina of cones | |
| eye | fovea | outer nuclear | |
| | | layer | |
| eye | fovea | outer plexiform | |
| | | layer | |
| eyelid | ciliary gland | | epithelial cell |
| eyelid | lacrimal gland | connective tissue | fibroblast |
| eyelid | lacrimal gland | serous acini | serous acinar |
| | | | epithelial cell |
| eyelid | levator palpebrae | | skeletal muscle cell |
| | superioris | | |
| eyelid | orbicularis oculi | | skeletal muscle cell |
| eyelid | palpebral | | columnar epithelial |
| | conjunctiva | | cell |
| eyelid | skin | skin | squamous epithelial |
| | | | cell |
| eyelid | tarsal plate | tarsal gland | epithelial cell |
| fallopian | epithelium | | ciliated cell |
| tube | | | |
| fallopian | epithelium | | smooth muscle cell |
| tube | | | |
| fallopian | mucosa | | peg cell |
| tube | | | |
| fallopian | serosa | | fibroblast |
| tube | | | |
| fibrocartilage | collagen fibers | | chondrocyte |
| fibrocartilage | | | |
| gallbladder | mucosa | | columnar epithelial |
| | | | cell |
| gallbladder | muscularis | | smooth muscle cell |
| | externa | | |
| gallbladder | | | Luschka's duct cell |
| gallbladder | | | paraganglion cell |
| gallbladder | serosa | | fibroblast |
| ganglion | capsule | | fibroblast |
| ganglion | | | ganglion cell |
| ganglion | | | satellite cell |
| ganglion | | | Schwann cell |
| heart | myocardium | | myocyte |
| heart | valve | | endothelial cell |
| heart | valve | | fibroblast |
| heart | valve | | smooth muscle cell |
| heart | | | adipocyte |
| heart | endocardium | | endothelial cell |
| heart | epicardium | | epithelial cell |
| heart | | | Purkinje cell |
| inflam- | | | basophil |
| matory | | | |
| inflam- | | | eosinophil |
| matory | | | |
| inflam- | | | lymphocyte |
| matory | | | |
| inflam- | | | macrophage |
| matory | | | |
| inflam- | | | mast cell |
| matory | | | |
| inflam- | | | monocyte |
| matory | | | |
| inflam- | | | neutrophil |
| matory | | | |
| inflam- | | | plasma cell |
| matory | | | |
| kidney | capsule | | fibroblast |
| kidney | cortex | Bowman's | epithelial cell |
| | | capsule | |
| kidney | cortex | collecting duct | epithelial cell |
| kidney | cortex | proximal | epithelial cell |
| | | convoluted | |
| | | tubule | |
| kidney | cortex | distal convoluted | epithelial cell |
| | | tubule | |
| kidney | cortex | glomerulus | glomerular |
| | | | endothelial cell |
| kidney | cortex | glomerulus | juxtaglomerular cell |
| kidney | cortex | glomerulus | mesangial cell |
| kidney | cortex | glomerulus | podocyte |
| kidney | inner medulla | collecting duct | epithelial cell |
| kidney | inner medulla | thin loop Henle | epithelial cell |
| kidney | inner medulla | papillae | epithelial cell |
| kidney | outer medulla | proximal | epithelial cell |
| | | convoluted tubule | |
| kidney | outer medulla | distal convoluted | epithelial cell |
| | | tubule | |
| kidney | outer medulla | thick loop Henle | epithelial cell |
| kidney | outer medulla | collecting duct | epithelial cell |
| kidney | outer medulla | thin loop Henle | epithelial cell |
| kidney | pelvis | | transitional |
| | | | epithelial cell |
| larynx | cartilage | | chondrocyte |
| larynx | mucosa | | squamous |
| | | | epithelial cell |
| larynx | seromucous gland | | gland epithelial cell |
| larynx | ventricular fold | | squamous |
| | | | epithelial cell |
| larynx | vocal fold | | squamous |
| | | | epithelial cell |
| larynx | vocalis muscle | | skeletal muscle |
| lip | epidermis | | keratinocyte |
| lip | nonkeratinizing | | squamous |
| | squamous | | epithelial cell |
| | epithelium | | |
| lip | salivary gland | | gland epithelial cell |
| lip | skeletal muscle | | muscle fiber |
| liver | hepatic artery | | endothelial cell |
| liver | hepatic artery | | smooth muscle cell |
| liver | portal vein | | endothelial cell |
| liver | portal vein | | smooth muscle cell |
| liver | | bile duct | epithelial cell |
| liver | | | hepatocyte |
| liver | | | Kupifer cell |
| liver | | | sinusoidal lining cell |
| lung | alveolus | | alveolar macrophage |
| lung | alveolus | capillary | endothelial cell |
| lung | alveolus | | type I pneumocyte |
| lung | alveolus | | type II pneumocyte |
| lung | bronchiole | cartilage | chondrocyte |
| lung | bronchiole | | respiratory epithelial |
| | | | cell |
| lymph node | cortex | germinal center | dendritic reticulum |
| | | | cell |
| lymph node | cortex | germinal center | lymphocyte |
| lymph node | cortex | germinal center | tingible body |
| | | | macrophage |
| lymph node | medulla | medulla | lymphocyte |
| lymph node | medulla | medulla | sinusoidal lining cell |
| lymph node | paracortex | | lymphocyte |
| lymphatic | capillary | | endothelial cell |
| nasal cavity | Bowman's gland | | Bowman's epithelial |
| | | | cell |
| nasal cavity | intraepithelial | | pseudostratified |
| | gland | | epithelial cell |
| nasal cavity | olfactory | | basal cell |
| | epithelium | | |
| nasal cavity | olfactory | | olfactory cell |
| | epithelium | | |
| nasal cavity | | | respiratory epithelial |
| | | | cell |
| nasal cavity | | | squamous epithelial |
| | | | cell |
| nasal cavity | olfactory | | sustentacular cell |
| | epithelium | | |
| nerve | endoneurium | | endothelial cell |
| nerve | epineurium | | epithelial cell |
| nerve | perineurium | | epithelial cell |
| nerve | nerve | | Schwann cell |
| nerve | axon | | |
| ovary | corpus luteum | | decidual cell |
| ovary | corpus luteum | | granulosa lutein cell |
| ovary | corpus luteum | luteinized stroma | fibroblast |
| ovary | corpus luteum | | theca lutein cell |
| ovary | epithelium | | surface (germinal) |
| | | | epithelial cell |
| ovary | follicle | | follicular cell |
| ovary | follicle | | granulosa cell |
| ovary | follicle | | oocyte |
| ovary | follicle | theca externa | theca cell |
| ovary | follicle | theca interna | theca cell |
| ovary | stroma | | fibroblast |
| ovary | tunica albuginea | | |
| pancreas | exocrine gland | | acinar cell |
| pancreas | exocrine gland | | centroacinar cell |
| pancreas | exocrine gland | | ductal epithelial cell |
| pancreas | islet of | glucagon | type a cell |
| | Langerhans | secreting | |
| pancreas | islet of | insulin secreting | type b cell |
| | Langerhans | | |
| pancreas | islet of | pancreatic | type c cell |
| | Langerhans | polypeptide | |
| pancreas | islet of | somatostatin | type d cell |
| | Langerhans | | |
| parathyroid | | | chief cell |
| parathyroid | | | oxyphil cell |
| parotid gland | intralobular duct | | ductal epithelial cell |
| parotid gland | serous acini | | serous acinar cell |
| penis | tunica albuginea | | |
| penis | corpus | | endothelial cell |
| | cavernosum | | |
| penis | corpus | | smooth muscle cell |
| | cavernosum | | |
| penis | corpus | | endothelial cell |
| | spongiosum | | |
| penis | corpus | | smooth muscle cell |
| | sponiosum | | |
| penis | cowper's gland | | epithelial cell |
| penis | glands of Littre | | gland epithelial |
| | | | cell |
| penis | skin | | squamous epithelial |
| | | | cell |
| penis | urethra | | pseudostratified |
| | | | epithelial cell |
| peritoneum | | | mesothelial cell |
| pineal body | | | neuroglial cell |
| pineal body | | | pinealocyte |
| pineal body | brain sand | | |
| pituitary | anterior | | acidophil |
| pituitary | anterior | | basophil |
| pituitary | anterior | | chromophobe |
| pituitary | posterior | | pituicyte |
| pituitary | rathke's pouch | | pars intermedia cell |
| pituitary | | | sinusoidal |
| | | | endothelial cell |
| placenta | chorionic villi | | capillary endothelial |
| | | | cell |
| placenta | chorionic villi | | syncytial trophoblast |
| placenta | decidua basalis | | decidual cell |
| placenta | | | cytotrophoblast |
| placenta | | | Hofbauer cell |
| pleura | | | mesothelial cell |
| prostate | ducts | | epithelial cell |
| prostate | ducts | | reserve cell |
| prostate | glands | | epithelial cell |
| prostate | glands | | reserve cell |
| prostate | stroma | | fibroblast |
| prostate | stroma | | smooth muscle cell |
| prostate | | | skeletal muscle cell |
| prostate | | | squamous epithelial |
| | | | cell |
| prostate | | | transitional |
| | | | epithelial cell |
| salivary | mucous acini | | mucous cell |
| gland | | | |
| salivary | serous acini | | serous cell |
| gland | | | |
| salivary | | | excretory duct cell |
| gland | | | |
| salivary | | | intercalary duct cell |
| gland | | | |
| salivary | | | myoepithelial cell |
| gland | | | |
| salivary | | | striated duct cell |
| gland | | | |
| seminal | | | basal cell |
| vesicle | | | |
| seminal | | | columnar cell |
| vesicle | | | |
| seminal | | | spermatozoa |
| vesicle | | | |
| skeletal | epimysium | | fibroblast |
| muscle | | | |
| skeletal | endomysium | endomysial fiber | |
| muscle | | | |
| skeletal | muscle fiber | | skeletal muscle cell |
| muscle | | | |
| skeletal | perimysium | | fibroblast |
| muscle | | | |
| skin | dermis | collagen fiber | |
| skin | dermis | elastin fiber | |
| skin | arrector pili | | smooth muscle cell |
| skin | dermis | | fibroblast |
| skin | eccrine gland | | ductal epithelial cell |
| skin | eccrine gland | | gland epithelial cell |
| skin | eccrine gland | | myoepithelial cell |
| skin | epidermis | | basal cell |
| skin | epidermis | | keratinocyte |
| skin | epidermis | | langerhan's cell |
| skin | epidermis | | melanocyte |
| skin | epidermis | | merkel cell |
| skin | hair follicle | | basal cell |
| skin | hypodermis | | adipocyte |
| skin | sebaceous gland | | sebaceous cell |
| skin | hair follicle | bulb | |
| skin | hair follicle | cortex | |
| skin | hair follicle | Inner root sheath | |
| skin | hair follicle | outer root sheath | |
| smooth | | | smooth muscle cell |
| muscle | | | |
| soft tissue | | | adipocyte |
| soft tissue | | | fibroblast |
| spinal cord | central canal | | ependymal cell |
| spinal cord | dorsal horn | | astrocyte |
| spinal cord | dorsal horn | | neurons |
| spinal cord | dorsal horn | | oligodendrocyte |
| spinal cord | meninges | | mesothelial cell |
| spinal cord | ventral horn | | astrocyte |
| spinal cord | ventral horn | | neuron |
| spinal cord | ventral horn | | oligodendrocyte |
| spinal cord | white matter | | astrocyte |
| spinal cord | white matter | | oligodendrocyte |
| spinal cord | | | microglial cell |
| spleen | central artery | | endothelial cell |
| spleen | central artery | | smooth muscle cell |
| spleen | lymphatic nodule | | dendritic reticulum |
| | | | cell |
| spleen | lymphatic nodule | germinal center | lymphocyte |
| spleen | lymphatic nodule | corona | lymphocyte |
| spleen | lymphatic nodule | | tingible body |
| | | | macrophage |
| spleen | marginal zone | | lymphocyte |
| spleen | periarterial | | lymphocyte |
| | lymphatic sheath | | |
| spleen | red pulp | sinusoid | erythrocytes |
| spleen | red pulp | cords of Billroth | macrophage |
| spleen | red pulp | cords of Billroth | plasma cell |
| spleen | red pulp | cords of Billroth | reticular cell |
| spleen | red pulp | sinusoid | sinusoidal lining cell |
| stomach | Auerbach's | | ganglion cell |
| | plexus | | |
| stomach | Auerbach's | | Schwann cell |
| | plexus | | |
| stomach | fundic gland | | chief cell |
| stomach | fundic gland | | mucous neck cell |
| stomach | fundic gland | | parietal cell |
| stomach | gastric pit | | surface lining cell |
| stomach | Meissner's plexus | | ganglion cell |
| stomach | Meissner's plexus | | Schwann cell |
| stomach | mucosa | | neuroendocrine cell |
| stomach | muscularis | | smooth muscle cell |
| | externa | | |
| stomach | muscularis | | smooth muscle cell |
| | mucosa | | |
| stomach | pyloric gland | | mucous cell |
| stomach | pyloric gland | | surface lining cell |
| stomach | serosa | | fibroblast |
| stomach | serosa | | mesothelial cell |
| stomach | submucosa | vessel | endothelial cell |
| stomach | submucosa | vessel | smooth muscle cell |
| synovium | | | subsynovial |
| | | | histiocyte (type II) |
| synovium | | | superficial |
| | | | synoviocyte (type I) |
| testis | rete testis | | epithelial cell |
| testis | seminiferous | | sertoli cell |
| | tubule | | |
| testis | seminiferous | | spermatid |
| | tubule | | |
| testis | seminiferous | | spermatocyte |
| | tubule | | |
| testis | seminiferous | | spermatogonia |
| | tubule | | |
| testis | stroma | | fibroblast |
| testis | stroma | | myoid cell |
| testis | tunica albuginea | | fibroblast |
| testis | | | Leydig cell |
| thymus | capsule | | fibroblast |
| thymus | cortex | | lymphocyte |
| thymus | cortex | | macrophage |
| thymus | Hassall's | | epithelial reticular |
| | corpuscle | | cell |
| thymus | medulla | | epithelial reticular |
| | | | cell |
| thymus | medulla | | lymphocyte |
| thymus | medulla | | macrophage |
| thymus | medulla | | plasma cell |
| thymus | septae | | fibroblast |
| thyroid | capsule | | fibroblast |
| thyroid | follicle | | follicular cell |
| thyroid | | | parafollicular cell |
| | | | (C cell) |
| thyroid | follicle | colloid | |
| tongue | circumvallate | glands of | serous epithelial cell |
| | papillae | von Ebner | |
| tongue | filiform papillae | keratinized | keratinocyte |
| | | squamous | |
| | | epithelium | |
| tongue | muscularis | skeletal muscle | muscle cell |
| tongue | taste bud | | basal cell |
| tongue | taste bud | | gustatory light cell |
| tongue | taste bud | | sustentacular dark |
| | | | cell |
| tongue | ventral | nonkeratinized | squamous cell |
| | | squamous | |
| | | epithelium | |
| tonsil | crypt | | squamous epithelial |
| | | | cell |
| tonsil | lymphatic nodule | | dendritic reticulum |
| | | | cell |
| tonsil | lymphatic nodule | germinal center | lymphocyte |
| tonsil | lymphatic nodule | corona | lymphocyte |
| tonsil | lymphatic nodule | | tingible body |
| | | | macrophage |
| tooth | crown | dentinal tubules | odontoblast |
| tooth | pulp | core | fibroblast |
| Tooth | crown | enamel | |
| Tooth | pulp | cell free zone | |
| Tooth | pulp | cell rich zone | |
| Tooth | pulp | dentin matrix | |
| Tooth | pulp | odontoblastic | |
| | | layer | |
| Tooth | root | cementum | |
| Tooth | root | periodontal | |
| | | ligament | |
| Tooth | root | dentin | |
| Tooth | root | Sharpey's fiber | |
| trachea | c-ring | cartilage | chondrocyte |
| trachea | c-ring | perichondrium | fibroblast |
| trachea | mucosa | | goblet cell |
| trachea | mucosa | | pseudostratified |
| | | | epithelial cell |
| trachea | submucosa | mucous gland | gland epithelial cell |
| trachea | submucosa | seromucous gland | gland epithelial cell |
| ureter | epithelium | | basal cell |
| ureter | epithelium | | dome-shaped cell |
| ureter | epithelium | | transitional |
| | | | epithelial cell |
| ureter | muscularis | | smooth muscle cell |
| ureter | subepithelial | | fibroblast |
| | connective tissue | | |
| urethra | connective tissue | | fibroblast |
| urethra | corpus | | endothelial cell |
| | spongiosum | | |
| urethra | corpus | | plasma cell |
| | spongiosum | | |
| urethra | epithelium | | pseudostratified |
| | | | epithelial cell |
| urethra | glands of littre | | mucous cell |
| urethra | intraepithelial | | epithelial cell |
| | gland | | |
| uterus | cervix | ectocervix | basal cell |
| uterus | cervix | endocervix | columnar epithelial |
| | | | cell |
| uterus | cervix | endocervical | glandular epithelial |
| | | glands | cell |
| uterus | cervix | lamina propria | lymphocyte |
| uterus | cervix | lamina propria | neutrophil |
| uterus | cervix | lamina propria | plasma cell |
| uterus | cervix | ectocervix | squamous cell |
| uterus | endometrium | | decidual cell |
| uterus | endometrium | helical artery | endothelial cell |
| uterus | endometrium | stratum basalis | epithelial cell |
| uterus | endometrium | stratum | epithelial cell |
| | | functionalis | |
| uterus | endometrium | stroma | fibroblast |
| uterus | endometrium | | macrophage |
| uterus | endometrium | | mast cell |
| uterus | endometrium | | neutrophil |
| uterus | endometrium | | plasma cell |
| uterus | endometrium | helical artery | smooth muscle cell |
| uterus | myometrium | vessel | endothelial cell |
| uterus | myometrium | | smooth muscle cell |
| uterus | myometrium | vessel | smooth muscle cell |
| vagina | mucosa | | squamous cell |
| vagina | muscularis | | smooth muscle cell |
| vagina | submucosa | vessel | endothelial cell |
| vagina | submucosa | | fibroblast |
| vagina | submucosa | | lymphocyte |
| vagina | submucosa | | macrophage |
| vagina | submucosa | | neutrophil |
| vagina | submucosa | vessel | smooth muscle cell |
| vein | tunica adventitia | | fibroblast |
| vein | tunica intima | | endothelial cell |
| vein | tunica media | | smooth muscle cell |
| vessel | tunica adventitia | | fibroblast |
| vessel | tunica intima | | endothelial cell |
| vessel | tunica media | | smooth muscle cell |

The brain is the most complex tissue in the body. The are myriad brain structures, and other structures, cell types, tissues, etc., that can be imaged with brain scans and recognized by this system that are not listed above.

Some diseases can be identified by accumulations of material within tissues that are used as hallmarks of that disease. These accumulations of material often form abnormal structures within tissues. Such accumulations can be located within cells (e.g., Lewy bodies in dopaminergic neurons of the substantia nigra in Parkinson's disease) or be found extracellularly (e.g., neuritic plaques in Alzheimer's disease). They can be, for example, glycoprotein, proteinaceous, lipid, crystalline, glycogen, and/or nucleic acid accumulations. Some can be identified in the image without the addition markers and others require selective markers to be attached to them.

Examples of proteinaceous accumulations (including glycoprotinaceous accumulations) useful for the diagnosis of specific diseases include: neuritic plaques and tangles in Alzheimer's disease, plaques in multiple sclerosis, prion proteins in spongiform encephalopathy, collagen in scleroderma, hyalin deposits or Mallory bodies in hyalin disease, deposits in Kimmelstiel-Wilson disease, Lewy bodies in Parkinson's disease and Lewy body disease, alpha-synuclein inclusions in glial cells in multiple system atrophies, atheromatous plaques in atherosclerosis, collagen in Type II diabetes, caseating granulomas in tuberculosis, and amyloid-beta precursor protein in inclusion-body myositis. Examples of lipid accumulations (including fatty accumulations) include: deposits in nutritional liver diseases , atheromatous plaques in atherosclerosis, fatty change in liver, foamy macrophages in atherosclerosis, xanthomas, and other lipid accumulation disorders, and fatty streaks in atherosclerosis. Examples of crystalline accumulations include: uric acid and calcium oxylate crystals in kidney stones, uric acid crystals in gout, calcium crystals in atherosclerotic plaques, calcium deposits in nephrolithiasis, calcium deposits in valvular heart disease, and psammoma bodies in papillary carcinoma. Examples of nucleic acid accumulations or inclusions include: viral DNA in herpes , viral DNA in cytomegalovirus, viral DNA in human papilloma virus, viral DNA in HIV, Councilman bodies in viral hepatitis, and molluscum bodies in molluscum contagiosum.

System Self-Teaching Based on High Certainty Recognition

The evaluation of the accumulated weight of the associated template assessments for an existing trained tissue/structure type experience defines the classification/recognition decision. For this and/or other reasons, the present methods can include dynamic system adaptability and self-organized evolution. When the referential assessment of a test tissue/cell structure falls within defined boundary limits (within an acceptable probability bandwidth) the system can automatically upgrade the training of each of the parameter-reference template recognition envelopes to include the slight variations in current sample experience. The system dynamically and automatically increases the density of its trained experience. If the referential assessment is outside previous experience, the nature of that divergence is apparent from the associations to each of the trained types (self teaching) and under significant statistical reoccurrence of similar divergent types, new references can be automatically generated and dynamically added to association matrix.

Locating and Quantifying Components that Include Distinctive Molecules

Using known methods, pixels which show colors emitted by a marker or a tag on a marker, or are otherwise wavelength distinguishable, can be identified and the intensity of the color can be correlated with quantity of the marked component. Similarly, some tissue components include molecules that can be directly distinguished in an image without the use of a marker. The level of association of the primary signal emitted by the component or marker or tag can be determined and localized to structures, cell types, etc. There are several suitable methods.

One method begins by identifying one pixel or contiguous pixels that show a distinctive signature indicating presence of the sought component, checks to determine if they are within or close to a nucleus, and, if so, identifies the nucleus type. If the component appears within a nucleus or within a radius so small that the component must be within the cell, the above described method can determine the cell type and whether the nucleus is normal or abnormal where the component appears. The system can also identify the tissue type. The tissue type will have a limited number of structures within it and each of those will be comprised of a limited number of cell types. If the identified cell type occurs in only one structure type within that tissue type, the structure is known.

In some cases, it is desired to first find a structure (which may be a substructure of a larger structure) and then determine whether the sought component is included in the structure: In this method, a large number of sample windows which may be overlapping, typically with each large enough to capture at least one possible candidate for a structure type in that tissue, are taken from the image. Each sample is compared to a template for the structure type using the neural networks as described above. Sample windows that are identified as showing the structure are then reduced in size at each edge in turn until the size reduction reduces the certainty of recognition.

In some embodiments, if the structure where the component occurs is one that has known substructures, many smaller windows which may be overlapping can sampled from the reduced window and compared to templates for the substructures. If a substructure is found, the smaller window is again reduced on each edge in turn until the certainty of recognition goes down.

If the structure or substructure has a boundary that can be determined by a change in pixel intensity, the boundary of the structure or substructure within the window or smaller window can be identified as a loop of pixels and each pixel showing the component can be checked to determine if it is on or within or outside the loop. The component intensities for all pixels on or within the loop can be summed to quantify the presence of the sought component.

In some cases the above methods can be reversed to start with each set of one or more contiguous pixels that show the presence of the component above a threshold. Then, a window surrounding the set of pixels is taken and checked for the presence of a structure known to occur in that tissue type. If none is found, the window is enlarged and the process is repeated until a structure is found. Then the boundary of the structure can be identified and a determination is made whether it includes the set of pixels showing the component.

While the above embodiments explain particular ways of implementing the invention, the invention should not be construed as limited by any of the above specific examples but rather only by the following claims:

1. A computer method using an image of an unknown tissue comprising cells of an organism for categorizing the unknown tissue into a class, comprising:
(a) receiving a pixel data image of an unknown tissue, the pixel data image showing tissue having a minimum dimension spanning at least about 120 microns, each pixel in the pixel data image having an image intensity value datum expressed with at least 6 significant bits;
(b) selecting at least one analysis window of pixel data from within the image and, from the pixel data for the analysis window, computing at least one parameter that constitutes a measure of a two-dimensional pattern, across at least two spatial dimensions in the image intensity value data having at least 6 significant bits for each pixel, from a two-dimensional grid of pixels within the window having a shortest dimension of at least 6 pixels to provide a computed parameter;
(c) comparing the computed parameter to at least two different corresponding parameters previously computed from images of tissues known to be of at least two different classes, thereby providing at least a first class and a second class; and
(e) determining whether the unknown tissue is more similar to the first class or the second class.

2. A computer readable data carrier containing a computer program which, when run on a computer, causes the computer to perform the method of claim 1.

3. The method of claim 1 wherein the first class of tissues is a single type of tissue and the second class of tissues is a plurality of other tissue types.

4. The method of claim 1 further comprising:
(f) comparing the computed parameter to corresponding parameters previously computed from images of tissue known to be of a third class;
(g) determining whether the computed parameter is more like previously computed parameters from images of tissue known to be of the third class than other parameters to which is was compared; and
(h) if the computed parameters are more like previously computed parameters from images of tissue known to be of the third class than other parameters to which it is compared, determining that the unknown tissue is probably of the third class.

5. The method of claim 1 where the comparing operation is performed using at least one neural network.

6. The method of claim 5 using at least two neural networks comprising a first neural network trained using images known to have pixel data with a first characteristic mode of data degradation and a second neural network trained using images known to have pixel data with a second characteristic mode of data degradation and the computed parameter is fed to both the first and the second neural networks.

7. The method of claim 1 wherein at least two parameters are computed in the computing operation and at least two neural networks are used in the comparing operation wherein:
(a) a first parameter is fed to a first network that was trained using said first parameter computed from images of tissue of the first class and images of tissue of the second class, and
(b) a second parameter is fed to a second network that was trained using said second parameter computed from images of tissue of the first class and images of tissue of the second class.

8. The method of claim 1 wherein the first class comprises a type of tissue and the second class comprises tissues other than the type of tissue.

9. The method of claim 1 wherein the first class is a first class of tissue, the second class is a second class of tissue, and the method includes at least one additional class of tissue on which the neural network was trained and the unknown tissue is determined to be probably of the class most similar to the computed parameter.

10. The method of claim 1 wherein the second class further comprises at least one additional class to provide a third class, and the comparing further comprises comparing the computed parameter to the third class and the determining further comprises determining whether the at least one tissue shown in the image is more similar to the first class, the second class or the third class.

11. The method of claim 1 where the image was taken from an exposed surface of a slice of tissue.

12. The method of claim 11 where, before the image was taken, the exposed surface was stained with a nuclear stain.

13. The method of claim 1 wherein the image data includes a third spatial dimension and the parameter computation computes a parameter across all three spatial dimensions.

14. The method of claim 1 where the image is taken in situ from a tissue of a living organism.

15. The method of claim 1 wherein the tissue is an animal tissue.

16. The method of claim 15 wherein the first class comprises a type of human tissue and the second class comprises human tissues not including the type of tissue.

17. The method of claim 16 wherein the first class is adrenal tissue.

18. The method of claim 16 wherein the first class is artery tissue.

19. The method of claim 16 wherein the first class is bladder tissue.

20. The method of claim 16 wherein the first class is bone tissue.

21. The method of claim 16 wherein the first class is bone marrow tissue.

22. The method of claim 16 wherein the first class is brain tissue.

23. The method of claim 16 wherein the first class is breast tissue.

24. The method of claim 16 wherein the first class is bronchus tissue.

25. The method of claim 16 wherein the first class is colon tissue.

26. The method of claim 16 wherein the first class is duodenum tissue.

27. The method of claim 16 wherein the first class is ear tissue.

28. The method of claim 16 wherein the first class is epididymis tissue.

29. The method of claim 16 wherein the first class is esophagus tissue.

30. The method of claim 16 wherein the first class is eye tissue.

31. The method of claim 16 wherein the first class is eyelid tissue.

32. The method of claim 16 wherein the first class is fallopian tube tissue.

33. The method of claim 16 wherein the first class is fibrocartilage tissue.

34. The method of claim 16 wherein the first class is gallbladde tissue.

35. The method of claim 16 wherein the first class is ganglion tissue.

36. The method of claim 16 wherein the first class is heart tissue.

37. The method of claim 16 wherein the first class is inflammatory tissue.

38. The method of claim 16 wherein the first class is kidney tissue.

39. The method of claim 16 wherein the first class is larynx tissue.

40. The method of claim 16 wherein the first class is lip tissue.

41. The method of claim 16 wherein the first class is liver tissue.

42. The method of claim 16 wherein the first class is lung tissue.

43. The method of claim 16 wherein the first class is lymph node tissue.

44. The method of claim 16 wherein the first class is lymphatic tissue.

45. The method of claim 16 wherein the first class is nasal cavity tissue.

46. The method of claim 16 wherein the first class is nerve tissue.

47. The method of claim 16 wherein the first class is ovary tissue.

48. The method of claim 16 wherein the first class is pancreas tissue.

49. The method of claim 16 wherein the first class is parathyroid tissue.

50. The method of claim 16 wherein the first class is parotid gland tissue.

51. The method of claim 16 wherein the first class is pen is tissue.

52. The method of claim 16 wherein the first class is peritoneum tissue.

53. The method of claim 16 wherein the first class is pineal body tissue.

54. The method of claim 16 wherein the first class is pituitary tissue.

55. The method of claim 16 wherein the first class is placenta tissue.

56. The method of claim 16 wherein the first class is pleura tissue.

57. The method of claim 16 wherein the first class is prostate tissue.

58. The method of claim 16 wherein the first class is salivary gland tissue.

59. The method of claim 16 wherein the first class is seminal vesicle tissue.

60. The method of claim 16 wherein the first class is skeletal muscle tissue.

61. The method of claim 16 wherein the first class is skin tissue.

62. The method of claim 16 wherein the first class is smooth muscle tissue.

63. The method of claim 16 wherein the first class is soft tissue tissue.

64. The method of claim 16 wherein the first class is spinal cord tissue.

65. The method of claim 16 wherein the first class is spleen tissue.

66. The method of claim 16 wherein the first class is stomach tissue.

67. The method of claim 16 wherein the first class is synovium tissue.

68. The method of claim 16 wherein the first class is testis tissue.

69. The method of claim 16 wherein the first class is thymus tissue.

70. The method of claim 16 wherein the first class is thyroid tissue.

71. The method of claim 16 wherein the first class is tongue tissue.

72. The method of claim 16 wherein the first class is tonsil tissue.

73. The method of claim 16 wherein the first class is tooth tissue.

74. The method of claim 16 wherein the first class is trachea tissue.

75. The method of claim 16 wherein the first class is ureter tissue.

76. The method of claim 16 wherein the first class is urethra tissue.

77. The method of claim 16 wherein the first class is uterus tissue.

78. The method of claim 16 wherein the first class is vagina tissue.

79. The method of claim 16 wherein the first class is vein tissue.

80. The method of claim 16 wherein the first class is vessel tissue.

81. A computer method using an image of a tissue comprising cells of an organism for determining whether a first tissue structure is present, comprising:
(a) receiving a pixel data image of a tissue, each pixel of the image having an image intensity value datum expressed with at least 6 significant bits;
(b) selecting at least one analysis window of pixel data from the image, the analysis window showing tissue with a minimum dimension of at least about 60 microns;
(c) from the pixel data for the analysis window, computing at least one parameter that constitutes a measure of a pattern across at least two spatial dimensions in the image intensity value data having at least 6 significant bits for each pixel from a two-dimensional grid of pixels within the window having a shortest dimension of at least 6 pixels to provide a computed parameter;
(d) comparing the computed parameter to at least two different corresponding parameters previously computed from images of tissue known to include tissue structures of at least two different classes, thereby providing at least a first class and a second class; and
(e) determining whether the image comprises a tissue structure that is more similar to the first class or the second class.

82. A computer readable data carrier containing a computer program which, when run on a computer, causes the computer to perform the method of claim 1.

83. The method of claim 1 wherein the first class of tissue structures is a single type of tissue structure of a tissue type and the second class of tissue structures is a plurality of other structures in tissue of the single type.

84. The method of claim 81 further comprising:
(g) comparing the computed parameter to corresponding parameters previously computed from images of tissue known to include a tissue structure of a third class;
(h) determining whether the computed parameter is more like previously computed parameters from tissue known to include the tissue structure of the third class than other parameters to which is was compared; and
(i) if the computed parameter is more like previously computed parameters from tissue known to include the tissue structure of the third class than other parameters to which it is compared, determining that the tissue probably includes the second tissue structure.

85. The method of claim 81 where the comparing operation is performed using at least one neural network.

86. The method of claim 85 using at least two neural networks comprising a first neural network trained using images known to have pixel data with a first characteristic mode of data degradation and a second neural network trained using images known to have pixel data with a second characteristic mode of data degradation and the computed parameter is fed to both the first and the second networks.

87. The method of claim 84 wherein two or more parameters are computed in the computing operation and two or more neural networks are used in the comparing operation wherein:
(a) a first parameter is fed to a first network that was trained using said first parameter computed from images of tissue including the tissue structure and images of tissue not including the tissue structure, and
(b) a second parameter is fed to a second network that was trained using said second parameter computed from images of tissue including the tissue structure and images of tissue not including the tissue structure.

88. The method of claim 81 wherein the method includes at least one additional class on which the neural network was trained and the tissue structure is determined to be probably in one of the first class, the second class, or the additional class.

89. The method of claim 81 wherein the first class comprises a first type of tissue, the second class comprises a second type of tissue, and the method includes at least one additional class comprising an additional type of tissue on which the neural network was trained and the at least one tissue structure of the image is determined to be probably of the class most similar to the computed parameter.

90. The method of claim 81 where the image was taken from an exposed surface of a slice of tissue.

91. The method of claim 90 where, before the image was taken, the exposed surface was stained with a nuclear stain.

92. The method of claim 81 wherein the tissue is human tissue and the tissue structure has a characteristic pattern that indicates disease.

93. The method of claim 92 wherein the disease is a disease indicated by proteinaceous accumulations.

94. The method of claim 92 wherein the disease is a disease indicated by lipid accumulations.

95. The method of claim 92 wherein the disease is a disease indicated by crystalline accumulations.

96. The method of claim 92 wherein the disease is a disease indicated by nucleic acid accumulations.

97. The method of claim 92 wherein the disease is a disease indicated by glycogen accumulations.

98. The method of claim 81 wherein the tissue is human tissue from Table 2 and the tissue structure is a structure or substructure from Table 2.

99. The method of claim 81 where the image is taken in situ from a tissue of a living organism.

100. The method of claim 81 further comprising identifying a set of contiguous pixels representing the tissue structure.

101. The method of claim 100 wherein:
(a) before the image is taken, a marker is added to the tissue, then,
(b) pixels where the marker appears in the image are identified by computer analysis, and,
(c) after pixels representing the tissue structure are identified, the locations of pixels representing the marker are compared with locations of pixels representing the tissue structure and a correlation of the two is determined.

102. The method of claim 101 wherein the marker marks a gene product.

103. The method of claim 101 wherein the marker marks a drug.

104. The method of claim 101 wherein the marker marks an antibody.

105. The method of claim 101 wherein the marker marks a ligand.

106. The method of claim 101 wherein, for at least one of the tissue structures that has a marker, a magnitude of the marker is measured by computer analysis of the image.

107. The method of claim 81 wherein the image data includes a third spatial dimension and the parameter computation computes a parameter across all three spatial dimensions.

108. A computer method for processing an image of tissue of an organism of a tissue type to determine whether a tissue structure includes a component, comprising:
(a) receiving a pixel data image of a tissue and selecting pixel data of an analysis windows from the image;
(b) from the pixel data for the analysis window, computing at least one parameter to provide a computed parameter;
(c) comparing the computed parameter to corresponding parameters previously computed from images of tissue of the tissue type known to include the tissue structure and images of the tissue type known to not include the tissue structure;
(d) if the computed parameters are more like previously computed parameters from tissue known to include the tissue structure than like previously computed parameters from tissue known to not include the tissue structure, determining that the analysis window probably includes the tissue structure;
(e) if the computed parameters are more like previously computed parameters from tissue known to not include the tissue structure than like previously computed parameters from tissue known to include the tissue structure, determining that the analysis window probably does not include the tissue structure;
(f) if the analysis window probably includes the tissue structure, identifying pixels within a boundary of the structure; and
(g) by analysis of pixel color intensity, determining whether pixels within the boundary show characteristics indicating presence of the component.

109. The method of claim 108 further comprising, before computing the parameter for the analysis window, by analysis of pixel color intensity, determining whether pixels within the analysis window show characteristics indicating presence of the component and, if not, continuing the method using another analysis window of the image.

110. The method of claim 108 further comprising, within the analysis window, identifying a substructure within the structure and determining whether pixels within the substructure show characteristics indicating presence of the component.

111. The method of claim 108 further comprising identifying a clump pixels representing of at least one nucleus nearest to pixels indicating presence of the component and, by image recognition, identifying a cell type represented by the clump of pixels.

112. The method of claim 108 where the component is rendered identifiable in the image by the addition of a marker.

113. The method of claim 111 where the marker is rendered identifiable in the image by the addition of a tag.

114. The method of claim 108 wherein the component is a gene product.

115. The method of claim 108 wherein the component is a drug .

116. The method of claim 108 wherein the component is an antibody.

117. The method of claim 108 wherein the component a ligand.

118. The method of claim 108 wherein a magnitude of the component is measured by computer analysis of the image.

119. A computer method for processing an image of tissue of an organism of a tissue type to determine whether a component is located in a tissue structure, comprising:
(a) receiving a pixel data image of a tissue and, by analysis of pixel color intensity, identifying a group of one or more contiguous pixels that shows characteristics indicating presence of the component;
(b) selecting from the pixels of the image an analysis window surrounding the group of pixels;
(c) from pixel data within the analysis window, computing at least one parameter to provide a computed parameter;
(d) comparing the computed parameter to corresponding parameters previously computed from images of tissue of the tissue type known to include the tissue structure and computed from images of the tissue type known to not include the tissue structure;
(e) if the computed parameter is more like previously computed parameters from tissue known to include the tissue structure than like previously computed parameters from tissue known to not include the tissue structure, determining that the analysis window probably includes the component within the tissue structure; and
(f) if the computed parameters are more like previously computed parameters from tissue known to not include the tissue structure than like previously computed parameters from tissue known to include the tissue structure, determining that the analysis window probably does not include the component within the tissue structure;

120. The method of claim 119 further comprising:;
(g) if the analysis window probably includes the component within the tissue structure, identifying pixels within a boundary of the structure; and
(h) by analysis of pixel color intensity, determining whether pixels within the boundary show characteristics indicating presence of the component.

121. The method of claim 119 further comprising identifying a clump of pixels representing a nucleus nearest to the group of pixels indicating presence of the component and, by performing image recognition on the clump of pixels, identifying a cell type of the clump.

122. The method of claim 119 where the component is rendered identifiable by the addition of a marker.

123. The method of claim 122 where the marker is rendered identifiable by the addition of a tag.

124. The method of claim 119 wherein the component is a gene product.

125. The method of claim 119 wherein the component is a drug.

126. The method of claim 119 wherein the component is an antibody.

127. The method of claim 119 wherein the component a ligand.

128. The method of claim 119 wherein a magnitude of the component is measured by computer analysis of the image.

129. A computer method using an image of at least one cell from an organism for determining a classification of cell nuclei, comprising:
(a) receiving a pixel data image of at least one cell nucleus, said image showing at least one image clump of contiguous pixels, the image clump having a minimum dimension about equal to a cell nucleus;
(b) selecting at least one analysis window of pixel data from within the image, the analysis window showing a pixel clump comprising at least 24 contiguous discrete pixels of nuclear material, the pixel clump having a shortest dimension of at least 6 pixels, each pixel in the pixel clump having an image intensity value datum expressed with at least 6 significant bits;
(c) from the pixel data for the analysis window, computing at least one parameter that constitutes a measure of a pattern across at least two spatial dimensions in the image intensity value data [having at least 6 significant bits for each pixel from a two-dimensional grid of pixels within the analysis window having a shortest dimension of at least 6 pixels, to provide a computed parameter;
(d) comparing the computed parameter to at least two different corresponding parameters previously computed from images of nuclei known to be of at least two different classes, thereby providing at least a first class and a second class; and
(e) determining whether the at least one nucleus shown in the image clump is more similar to the first class or the second class.

130. A computer readable data carrier containing a computer program which, when run on a computer, causes the computer to perform the method of claim 1.

131 The method of claim 1 wherein the first class comprises nuclei of a single type and the second class comprises nuclei of a plurality of types not including the single type.

132. The method of claim 129 wherein the second class further comprises at least one additional class to provide a third class, and the comparing further comprises comparing the computed parameter to the third class and the determining further comprises determining whether the at least one nucleus shown in the image clump is more similar to the first class, the second class or the third class.

133. The method of claim 129 where the comparing operation is performed using at least one neural network.

134. The method of claim 133 using at least two neural networks comprising a first neural network trained using images known to have pixel data with a first characteristic mode of data degradation and a second neural network trained using images known to have pixel data with a second characteristic mode of data degradation and the computed parameter is fed to both the first and the second networks.

135 The method of claim 129 wherein the first class comprises a first type of nucleus and the second class comprises a second type of nucleus different from the first type of nucleus.

136. The method of claim 133 wherein the first class comprises a first type of nucleus, the second class comprises a second type of nucleus, and the method includes at least one additional class comprising an additional type of nucleus on which the neural network was trained and the at least one nucleus of the clump of pixels is determined to be probably of the class most similar to the computed parameter.

137. The method of claim 129 where the image was taken from an exposed surface of a slice of tissue of multiple cells in fixed relation to each other.

138. The method of claim 137 where, before the image was taken, the exposed surface was stained with a nuclear stain.

139. The method of claim 129 wherein the at least one nucleus of the first class is in a normal cell of a human cell type and the nuclei of the second class are in cells of that type that have a representation in the image indicative of an abnormality in the cells.

140. The method of claim 139 wherein the abnormality indicates a proliferative disease.

141. The method of claim 139 wherein the abnormality is neoplasia.

142. The method of claim 139 wherein the abnormality indicates an infectious disease.

143. The method of claim 139 wherein the abnormality indicates an inflammatory disease.

144 The method of claim 139 wherein the abnormality indicates a degenerative disease.

145. The method of claim 139 wherein the abnormality indicates an autoimmune disease.

146. The method of claim 139 wherein the abnormality indicates chemical injury.

147. The method of claim 139 wherein the abnormality indicates anoxic injury.

148. The method of claim 139 wherein the abnormality indicates a metabolic disease.

149. The method of claim 139 wherein the abnormality indicates a genetic disease.

150. The method of claim 139 wherein the abnormality indicates a disease listed in Table 1.

151. The method of claim 129 wherein the at least one nucleus of the first class is in a human cell listed in Table 2.

152. The method of claim 129 where the image was taken of at least one dissociated cell.

153. The method of claim 147 where the dissociated cell is at least one of a blood cell, a PAP smear cell, and an inflammatory cell.

154. The method of claim 129 wherein the at least one nucleus of the first class is of a cell fixed in relation to surrounding tissue and the at least one nucleus of the second class is of an inflammatory cell.

155. The method of claim 154 further comprising counting a number of inflammatory cells and reporting a measure based on the number of inflammatory cells.

156. The method of claim 129 wherein the nuclei of the first class are of a first type of inflammatory cell and the nuclei of the second class are of a second type of inflammatory cell.

157. The method of claim 156 further comprising counting a number of each type of inflammatory cell and reporting a measure based on the numbers of each type of inflammatory cell.

158. The method of claim 142 wherein the at least one nucleus of the first class is of a first type of inflammatory cell, the at least one nucleus of the second class is of a second type of inflammatory cell, and the at least one nucleus of the additional class is of at least one additional type of inflammatory cell.

159. The method of claim 137 wherein the nuclei of the first class are of a first cell type and the nuclei of the second class are of a second cell type.

160. The method of claim 149 wherein the first cell type consists essentially of cells in fixed relation to each other and the second cell type comprises at least one inflammatory cell.

161. The method of claim 129 wherein the image is taken in situ from a tissue of multiple cells in fixed relation to each other in a living organism.

162. The method of claim 129 wherein:
(a) before the image is taken, a marker is added to the at least one cell from an organism, then,
(b) locations where the marker appears in the image are identified by computer analysis, and,
(c) after the image clumps with nuclei of a class are designated, the marker locations are compared with previously computed locations of the marker for the class, and a correlation of the two is determined.

163. The method of claim 162 wherein the marker marks a gene product.

164. The method of claim 162 wherein the marker marks a drug.

165. The method of claim 162 wherein the marker marks an antibody.

166. The method of claim 162 wherein the marker marks a ligand.

167. The method of claim 162 wherein, for at least one nucleus represented in an image clump that shows a marker, a magnitude of the marker is measured by computer analysis of the image.

168. The method of claim 129 wherein the cells are of an animal tissue.

169. The method of claim 168 wherein the cells are of a human tissue.

170. The method of claim F wherein the image data includes a third spatial dimension and the parameter computation computes at least one parameter across all three spatial dimensions.

171. A computer method for processing an image of tissue of an organism to locate a component and identify a cell type that includes the component, comprising:
(a) receiving a pixel data image of tissue including a plurality of cells in fixed relation to each other, said image showing at least two pixel clumps, each pixel clump showing at least one cell nuclei;
(b) by analysis of pixel color intensity of the pixel data image, identifying a group of one or more contiguous pixels showing characteristics indicating presence of the component;
(c) by image recognition, identifying within the pixel data image a closest pixel clump that is closest to said group of pixels and computing at least one parameter from pixel data for pixels within the closest pixel clump to provide a computed parameter;
(d) comparing the computed parameter to at least one corresponding parameter previously computed from nuclei known to be of a cell type to provide a first cell type and to at least one corresponding parameter previously computed from nuclei known to not be of the cell type to provide a second cell type;
(e) comparing the computed parameter to at least two different corresponding parameters previously computed from images of nuclei known to be of at least two different classes, thereby providing at least a first class and a second class; and
(f) determining whether the at least one nucleus shown in the image clump is more similar to the first class or the second class.

172. The method of claim 171 where the component is rendered identifiable in the image by the addition of a marker.

173. The method of claim 172 where the marker is rendered identifiable in the image by addition of a tag.

174. The method of claim 171 wherein the component is a gene product.

175. The method of claim 171 wherein the component is a drug.

176. The method of claim 171 wherein the component is an antibody.

177. The method of claim 171 wherein the component a ligand.

178. The method of claim 171 wherein a magnitude of the component is measured by computer analysis of pixel intensity of pixels within the group.

179. A computer method for processing an image of tissue of an organism to determine whether a cell type includes a component, comprising:
(a) receiving a pixel data image of tissue including a plurality of cells in fixed relation to each other, said image showing all of at least one clump of pixels representing at least one cell nucleus;
(b) defining a boundary of an area comprising pixels within a distance of the pixel clump;
(c) by analysis of pixel color intensity, determining whether pixels within the boundary show characteristics indicating presence of the component;
(d) if the area includes pixels showing said presence, computing at least one parameter from pixel data for pixels within the pixel clump to provide a computed parameter;
(e) comparing the computed parameter to at least two different corresponding parameters previously computed from images of nuclei known to be of at least two different classes, thereby providing at least a first class and a second class; and
(f) determining whether the at least one nucleus shown in the image clump is more similar to the first class or the second class.

180. The method of claim 179 where the distance is zero such that the area is coextensive with the pixel clump.

181. The method of claim 179 where the distance is greater than zero such that the area is larger than the pixel clump.

182. The method of claim 179 where the component is rendered identifiable in the image by the addition of a marker.

183. The method of claim 182 where the marker is rendered identifiable in the image by the addition of a tag.

184. The method of claim 171 wherein the component is a gene product.

185. The method of claim 171 wherein the component is a rug.

186. The method of claim 171 wherein the component is an antibody.

187. The method of claim 171 wherein the component a ligand.

188. The method of claim 171 wherein a magnitude of the component is measured by computer analysis of the image.
